(19) United States
(12) Patent Application Publication
(10) Pub. No.: US 2026/0261562 A1
(43) Pub. Date: Sep. 3, 2026

(54) RESTRICTIONS FOR SOFTWARE ASSURANCE WITHIN A CLOUD ENVIRONMENT

(71) Applicant: Oracle International Corporation, Redwood Shores, CA (US)

(72) Inventors: Girish Nagaraja, Seattle, WA (US); Vineet Sarda, Seattle, WA (US); Ankush Gupta, Seattle, WA (US); Matias Brutti, Auburn, WA (US); Nachiketh Potlapally, Arlington, VA (US); Barry Shilmover, Seattle, WA (US)

(73) Assignee: Oracle International Corporation, Redwood Shores, CA (US)

(21) Appl. No.: 19/069,000

(22) Filed: Mar. 3, 2025

(51) Int. Cl. H04L 9/40

(52) U.S. Cl. CPC H04L 63/105; H04L 63/0245; H04L 63/0428; H04L 63/20

(57) ABSTRACT

Techniques for enforcing restrictions for software assurance within a cloud environment are disclosed. A customer section is established within a cloud environment, the customer section including a plurality of cloud resources. One or more restriction policies are caused to be stored within the customer section. One or more operations of the customer section are restricted. In an example, restricting the one or more operations of the customer section includes routing traffic to and from the customer section through a restricting section of the cloud environment. In an example, restricting the one or more operations of the customer section further includes performing the restricting of the one or more operations of the customer section at least in part in accordance with the one or more restriction policies.

### BACKGROUND

A cloud provider provides on-demand, scalable computing resources (e.g., a cloud environment) to its cloud customers. A cloud customer generally desires to run its cloud resources without monitoring, scanning, or other interference by the cloud provider or other cloud customer. Therefore, the cloud provider offers “tenancies” to its cloud customers. A tenancy is an isolated partition within the cloud environment, such that resources in different tenancies are isolated from each other unless explicitly shared. Each tenancy runs a plurality of virtual machine compute instances.

### BRIEF SUMMARY

In various embodiments, a non-transitory computer-readable medium includes instructions that when executed by one or more processors, cause the one or more processors to perform operations including: establishing a customer section within a cloud environment, the customer section comprising a plurality of customer cloud resources configured to execute customer workload; establishing a plurality of control layers, each control layer corresponding to a respective cloud restriction type, wherein the cloud restriction types comprise at least two of: a first cloud restriction type associated with prohibiting gateways that are attached to the customer section and not a restricting section; a second cloud restriction type associated with prohibiting transmission of traffic based on caller credentials; a third cloud restriction type associated with prohibiting transmission of traffic based on at least one API request type or API request parameters; a fourth cloud restriction type associated with routing traffic to and/or from the customer section through the restricting section, wherein the restricting section comprises a plurality of monitoring cloud resources; a fifth cloud restriction type associated with a security zone that encompasses at least a portion of the customer section; a sixth cloud restriction type associated with engaging locks on one or more of the plurality of customer cloud resources within the customer section, wherein any user and/or administrator of the customer section cannot control engaging and/or disengaging the locks; a seventh cloud restriction type associated with setting an upper limit for a type of operation to be performed by the customer section, or an upper limit for a type of resource to be accessed by the customer section, such that a number of times the type of operation can be performed or a number of times the type of resource can be accessed by the customer section is limited by the upper limit; and an eighth cloud restriction type associated with monitoring and recoding a secure shell (SSH) session or a zero trust bastion (ZTB) session in which the customer section participates; restricting the traffic to and/or from the customer section at least by applying the plurality of control layers to the traffic to and/or from the customer section.

In an example, the operations include: storing one or more keys within a tenancy of the cloud environment, the tenancy different from the customer section, wherein a key of the one or more keys is usable to unlock at least one cloud restriction type, such that the at least one cloud restriction type can be modified, deleted, and/or bypassed while being unlocked by the key of the one or more keys. In an example, the one or more keys comprise at least one of (i) an encryption key usable to unlock the at least one cloud restriction type, (ii) a session token usable to unlock the at least one cloud restriction type, and (iii) a user principal usable to unlock the at least one cloud restriction type, wherein the keys are non-accessible to any user or any administrator of the customer section. In an example, the operations include: causing to store one or more restriction policies within the customer section, wherein at least one cloud restriction types operate in accordance with the one or more restriction policies.

In an example, the operations include: causing to store one or more security zone policies, wherein the one or more security zone policies are associated with the security zone within the customer section, such that any ingress application programming interface (API) request inbound to any cloud resource within the security zone is allowed or denied passage to its destination in accordance with the one or more security zone policies. In an example, the operations include: causing to store one or more security zone unlocking policies within the customer section, wherein the one or more security zone unlocking policies are associated with restriction actions undertaken while at least one of the one or more security zone policies is at an unlocked state. In an example, routing traffic to and/or from the customer section through the restricting section comprises: routing all traffic to and from the customer section through one or more gateways of the restricting section of the cloud environment. In an example, the operations further include: analyzing, using one or more of the plurality of monitoring cloud resources, at least some of the traffic routed through the restricting section, aiming detect anomalous issues within a plurality of payloads within the at least some of the traffic; and selectively allowing or denying passage of each payload to its corresponding destination, based at least in part on whether any anomalous issue was detected for the payload. In an example, the first cloud restriction type associated with prohibiting gateways allows gateways within the restricting section, such that external access to the customer section is through the restricting section of the cloud environment. In an example, the seventh cloud restriction type associated with setting the upper limit comprises setting an upper limit on a number public endpoints that the restricted customer section has access to.

In an example, the cloud restriction types comprise each of the first cloud restriction type, the second cloud restriction type, the third cloud restriction type, the fourth cloud restriction, the fifth cloud restriction type, the sixth cloud restriction type, the seventh cloud restriction type, and the eighth cloud restriction type. In an example, the customer section is a customer tenancy rented to a cloud customer, or a compartment within the customer tenancy rented to the cloud customer. In an example, the restricting section comprises a gateway tenancy operated by an assurance administrator. In an example, any user and administrator of the customer section does not have administrative privileges to alter or configure any of the restriction types.

In various embodiments, a method comprises: establishing a customer section within a cloud environment, the customer section comprising a plurality of customer cloud resources configured to execute customer workload; establishing a plurality of control layers, each control layer corresponding to a respective cloud restriction type, wherein the cloud restriction types comprise at least two of: a first cloud restriction type associated with prohibiting gateways that are attached to the customer section and not a restricting section; a second cloud restriction type associated with prohibiting transmission of traffic based on caller credentials; a third cloud restriction type associated with prohibiting transmission of traffic based on at least one API request type or API request parameters; a fourth cloud restriction type associated with routing traffic to and/or from the customer section through the restricting section, wherein the restricting section comprises a plurality of monitoring cloud resources; a fifth cloud restriction type associated with a security zone that encompasses at least a portion of the customer section; a sixth cloud restriction type associated with engaging locks on one or more of the plurality of customer cloud resources within the customer section, wherein any user and/or administrator of the customer section cannot control engaging and/or disengaging the locks; a seventh cloud restriction type associated with setting an upper limit for a type of operation to be performed by the customer section, or an upper limit for a type of resource to be accessed by the customer section, such that a number of times the type of operation can be performed or a number of times the type of resource can be accessed by the customer section is limited by the upper limit; and an eighth cloud restriction type associated with monitoring and recoding a secure shell (SSH) session or a zero trust bastion (ZTB) session in which the customer section participates; restricting the traffic to and/or from the customer section at least by applying the plurality of control layers to the traffic to and/or from the customer section.

In an example, any user and administrator of the customer section does not have administrative privileges to alter or configure any of the restriction types. In an example, the customer section is a customer tenancy rented to a cloud customer, or a compartment within the customer tenancy rented to the cloud customer, and wherein the restricting section comprises a gateway tenancy operated by an assurance administrator. In an example, the operations further include: analyzing, using one or more of the plurality of monitoring cloud resources, at least some of the traffic routed through the restricting section, aiming detect anomalous issues within a plurality of payloads within the at least some of the traffic; and selectively allowing or denying passage of each payload to its corresponding destination, based at least in part on whether any anomalous issue was detected for the payload.

In various embodiments, a system comprises: one or more processors; and one or more non-transitory computer-readable media storing instructions, which, when executed by the system, cause the system to perform a set of actions including: establishing a customer section within a cloud environment, the customer section comprising a plurality of customer cloud resources configured to execute customer workload; establishing a plurality of control layers, each control layer corresponding to a respective cloud restriction type, wherein the cloud restriction types comprise at least two of: a first cloud restriction type associated with prohibiting gateways that are attached to the customer section and not a restricting section; a second cloud restriction type associated with prohibiting transmission of traffic based on caller credentials; a third cloud restriction type associated with prohibiting transmission of traffic based on at least one API request type or API request parameters; a fourth cloud restriction type associated with routing traffic to and/or from the customer section through the restricting section, wherein the restricting section comprises a plurality of monitoring cloud resources; a fifth cloud restriction type associated with a security zone that encompasses at least a portion of the customer section; a sixth cloud restriction type associated with engaging locks on one or more of the plurality of customer cloud resources within the customer section, wherein any user and/or administrator of the customer section cannot control engaging and/or disengaging the locks; a seventh cloud restriction type associated with setting an upper limit for a type of operation to be performed by the customer section, or an upper limit for a type of resource to be accessed by the customer section, such that a number of times the type of operation can be performed or a number of times the type of resource can be accessed by the customer section is limited by the upper limit; and an eighth cloud restriction type associated with monitoring and recoding a secure shell (SSH) session or a zero trust bastion (ZTB) session in which the customer section participates; restricting the traffic to and/or from the customer section at least by applying the plurality of control layers to the traffic to and/or from the customer section. In an example, any user and administrator of the customer section does not have administrative privileges to alter or configure any of the restriction types.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a block diagram of a system including a cloud environment, wherein the cloud environment comprises one or more customer sections, where a restricting section at least in part restricts operations of the customer sections.

FIG. 2 illustrates a plurality of sets of gateways within a restricting assurance administrator section controlling traffic to and/or from a corresponding plurality of restricted customer sections.

FIG. 3 illustrates a block diagram of a system including a cloud environment, wherein the cloud environment comprises one or more restricted customer sections, where a restricting assurance administrator at least in part restricts operations of the restricted customer sections, and wherein the cloud environment further includes (i) restriction policies stored within the restricted customer sections, and/or (ii) keys for unlocking one or more restriction policies, the keys stored within one or more service tenancies of the cloud environment.

FIG. 4 illustrates a security zone established within a restricted customer section of a cloud environment.

FIG. 5 illustrates one or more service gateways within a restricting assurance administrator section, where the service gateways allow access to services provided by the provider of the cloud environment and/or provided by off-cloud services.

FIG. 6 illustrates a layered approach to implementing a ring of controls on an ingress request to a cloud resource of a restricted customer section of a cloud environment.

FIG. 7 illustrates a layered approach to implementing a ring of controls on an egress request from a cloud resource of a restricted customer section of a cloud environment.

FIG. 8 is a flow diagram depicting a method for restricting operations of a restricted customer section within a cloud environment.

FIG. 9 depicts a simplified diagram of a distributed system for implementing certain aspects.

FIG. 10 is a simplified block diagram of one or more components of a system environment by which services provided by one or more components of an embodiment system may be offered as cloud services, in accordance with certain aspects.

FIG. 11 illustrates an example computer system that may be used to implement certain aspects.

### DETAILED DESCRIPTION

Maintaining security of a cloud environment involves controlling access to cloud resources based on permissions specified by respective cloud customers. A cloud customer can grant permissions for accessing cloud resources that it rents, but the cloud customer should not be able to grant permissions for accessing cloud resources rented by other customers. A tenancy is a conceptual bucket that holds cloud resources belonging to a particular cloud customer. Thus, a cloud provider of a cloud environment provides each cloud customer a “tenancy.” A tenancy is an isolated partition within the cloud environment, such that resources in different tenancies are isolated from each other unless explicitly shared. Generally, an administrator of a tenancy has administrative rights to set access policies for cloud resources in the tenancy; an administrator of a tenancy does not have administrative rights to set access policies for cloud resources in another tenancy. For purposes of this disclosure and unless otherwise stated, a tenancy rented out to a customer of the cloud environment is also referred to as a customer tenancy. A tenancy of a cloud customer includes a plurality of active cloud resources, such as compute instances that are used to host virtual machines. The cloud provider may also have control on one or more tenancies (e.g., cloud provider tenancies), through which the cloud provider may provide one or more services to the cloud customers. Such a tenancy is also referred to as a service tenancy.

Compartments are logical boundaries that group one or more cloud resources. Each cloud resource exists in a compartment. Compartments are hierarchical constructs that allow customers to vertically manage resources. These constructs can be used for a number of purposes, including, but not limited to: setting access policies for cloud resources on a compartment basis (security), setting usage limits or billing policies on a compartment basis (metering/billing), setting governance or compliance rules on a compartment basis (compliance/audit), serving as a container for resources that are moved as a group (e.g., moving resources in one tenancy into a compartment of another tenancy) (mergers/changes), and/or serving as a container for resources that interact with a third-party (third-party integrations). Policies may be specific to a given compartment and not to other compartments.

A tenancy is a root compartment. Each tenancy is associated with a tenancy administrator. The tenancy administrator has permissions to define which users can perform which actions on which resources within the tenancy. The root compartment may have child compartments nested within the root compartment, and different policies may be specified for the child compartments. The root compartment may also have policies that apply to all child compartments within the root compartment. Compartments may be further subdivided depending on the implementation.

For purposes of this disclosure and unless otherwise stated, a “section” of a cloud environment refers to (i) either a tenancy of the cloud environment, or (ii) a compartment within a tenancy. Thus, a section may be a compartment or a tenancy. A section of the cloud environment may be rented to a cloud customer. A “customer section,” for purposes of this disclosure and unless otherwise stated, refers to a tenancy, or a compartment within a tenancy, which is rented to a cloud customer, e.g., by a provider of the cloud environment.

In a typical scenario, a cloud customer renting a customer tenancy within a cloud environment may use cloud resources within the customer tenancy, independent of any major oversight from a provider of the cloud environment or any third-party oversight. For example, the cloud customer can ingress and/or egress data from and/or to a customer section, with minimal or no oversight from the provider of the cloud environment or from another third party. However, in the context of software assurance described herein, an additional role of an assurance administrator is added into the picture. The assurance administrator may or may not be the same as the cloud provider. In an example, the assurance administrator acts as a “trusted technology provider” (TTP). With regard to the subject disclosure, in an example, the assurance administrator has a monitoring role over a manner in which the cloud customer is using cloud resources within the customer section. In an example, there may be a lack of trust between the assurance administrator and an operator of the customer tenancy. Hence, in an example, the assurance administrator may want to at least in part monitor traffic going to, or coming out of the customer section. The assurance administrator may want to ensure that the cloud customer is compliant with guidelines mutually agreed between the cloud customer and the assurance administrator, as will be described below in further detail.

Accordingly, techniques are described herein for the assurance administrator to restrict operations of one or more customer sections of the cloud environment, e.g., in order to implement software assurance within the cloud environment. Because one or more customer sections are being restricted, each such customer section is referred to herein as a “restricted customer section” of the cloud environment.

In an example, a section operated by the assurance administrator at least in part restricts operation of the restricted customer section. Such a section operated by the assurance administrator is also referred to herein as a restricting assurance administrator section.

In an example, the restricting assurance administrator section comprises one or more gateways, and at least some or all the traffic to and/or from a restricted customer section are transmitted through the gateways of the restricting assurance administrator section. In an example, because the gateways are operated by the assurance administrator, the assurance administrator configures the gateways, e.g., to impose one or more restrictions on the restricted customer section, as described below in further detail. Cloud resources of the restricted customer section communicate, through the gateways of the restricting assurance administrator section, with a plurality of components and/or services that are within the cloud environment and/or external to the cloud environment.

In an example, there are multiple layers of restrictions on the restricted customer section. For example, the restricting assurance administrator section comprises, in addition to the gateways, a plurality of filter services. A filter service is configured to inspect traffic destined for, or originating from, a cloud resource of a restricted customer section. In an example, the filter services perform software assurance on at least a section of, or all of, the traffic destined for, or originating from, cloud resources of the restricted customer section. For example, the filter services analyze the traffic for anomalous or malicious data, e.g., in real or near-real time. In an example, if a payload with such anomalous or malicious data is detected by the filter services, the gateways one of (i) deny passage of such a payload to its intended destination, or (ii) cause modification of the payload to resolve the anomalous issue, and then allow passage of the modified payload to its intended destination. On the other hand, if the filter services fail to detect any anomalous issues with the payload, the filter services cause the gateways to allow passage of the payload to its intended destination.

In an example, to ensure that traffic to and/or from the restricted customer section transits via the gateways of the restricting assurance administrator section, the assurance administrator imposes a plurality of restrictions on the restricted customer sections. For example, restrictions are placed on operations that can possibly result in data exfiltration to and/or from the restricted customer section by bypassing the gateways of the restricting assurance administrator section. For example, multiple “rings of controls” are imposed around the restricted customer section, resulting in implementation of software assurance of the restricted customer section through the gateway and the filter services of the restricting assurance administrator section.

In an example, the restricting assurance administrator section comprises a storage repository storing gateway restriction policies, which dictate one or more policies for operation of the gateways within the restricting assurance administrator section. For example, the gateway restriction policies dictate which cloud resource within the restricted customer section can establish a connection, through the gateways, to which resource within or external to the cloud environment.

In an example, the restricting assurance administrator section further comprises a storage repository storing network restriction policies. The network restriction policies dictate one or more policies for setting up network resources by cloud resources within the restricted customer section. For example, the network restriction policies implement network-based access control (NBAC) restrictions on the restricted customer sections, as will be described below in further detail. In an example, the network restriction policies ensure that external access to a restricted customer section is through a restricting assurance administrator section, and that the cloud customer cannot transmit data to and/or from the restricted customer section by bypassing the restricting assurance administrator section.

In an example, the cloud environment further includes (i) a plurality of restriction policies stored within the restricted customer section, and/or (ii) keys for unlocking one or more restriction policies, where the keys are stored within one or more service tenancies operated by the provider of the cloud environment. In an example, various restriction policies within the cloud environment may be “locked”. For example, because of lack of trust between the assurance administrator and the cloud customer, the assurance administrator may not allow any user and/or administrator of the cloud customer to create, modify, and/or delete such restriction policies. Accordingly, locks may be implemented within the cloud environment, where the locks may disallow any user and/or administrator of the restricted customer sections and/or personnel of the cloud customer from creating, modifying, and/or deleting such restriction policies. In an example, keys to such locks may be stored in one or more service tenancies. Different examples of locks and corresponding keys are described below in further detail.

In an example, examples of the restriction policies stored within the restricted customer section include one or more security zone policies. In an example, the assurance administrator causes implementation of a security zone within a restricted customer section, where cloud resources within a security zone of the restricted customer section have to adhere to a plurality of security zone policies. The security zone within a restricted customer section is a logical partitioning within the restricted customer section, where cloud resources within the security zone are exposed to the corresponding security zone policies of the security zone. In an example, a security zone may encompass an entirety of a customer tenancy, or a part (such as one or more compartments) of the customer tenancy, and includes a plurality of cloud resources of the restricted customer section. In an example, the cloud resources within the security zone also includes a storage repository storing a plurality of restriction policies, including security zone policies associated with the security zone. In an example, a security zone policy is a denial policy, which denies an incoming API call destined for a cloud resource within the security zone, e.g., if the API call violates the security zone policy. For example, the cloud environment comprises a service tenancy, which is operated by a provider of the cloud environment and/or by the assurance administrator. In any case, the service tenancy is not operated by the cloud customer, to whom the restricted customer section is rented. In an example, the service tenancy executes a proxy service that facilitates in enforcing the security zone within the restricted customer section. For example, the proxy service intercepts a plurality of API calls destined for one or more cloud resources within the security zone of the restricted customer section. In an example, any API call destined for a cloud resource within the security zone has to pass through the proxy service. In an example, the proxy service includes a security zone plugin. The security zone plugin determines if an API call (which is destined for a cloud resource within the security zone) matches with any of the security zone policies. If the API call matches with at least a security zone policy, the proxy service blocks passage of the API call to its intended destination within the security zone. On the other hand, if the API call does not match with any of the security zone policies, the proxy service allows passage of the API call to its intended destination within the security zone.

In an example, the assurance administrator (e.g., after reaching an agreement with the cloud customer) may temporarily unlock or bypass a security zone policy, e.g., in order to allow the cloud customer to receive an API call that would otherwise be blocked by the security zone policy. Thus, when one or more security zone policies are unlocked, the security zone plugin and/or the proxy service do not implement the security zone policies. In an example, when one or more security zone policies are unlocked, API calls made to the restricted customer section are monitored and logged by the proxy service. Monitoring and logging of the API calls during the unlocked state of the security zone policies may be dictated by one or more security zone unlocking policies, as will be described below in further detail.

In an example, the restriction policies stored within the restricted customer section further include access policies. In an example, the access policies are identity and access management (IAM) policies enforced for the restricted customer section. In an example, personnel of the cloud customer (such as users and/or administrators of the cloud customer) may not be able to create, modify, and/or delete the access policies, as such access policies are locked, and can be unlocked using the access policy keys stored within a service tenancy, as also described above. In an example, the access policies are directed towards denying unauthorized access to network sources, and enforces network sources specified in one or more policies for network restriction policies. In an example, an IAM service, based on the access policies, verifies an identity of a requester from which a request is received (where the request originates for, or is destined for a restricted component), and determines whether the requester is authorized to transmit the request. Access policies dictate who can access which resources within the cloud environment, and how.

In an example, one or more service gateways (SGW) within the restricting assurance administrator section allow access to services provided by the provider of the cloud environment and/or provided by off-cloud services. In an example, services provided by non-cloud provider may not support access policies, network restriction policies, and/or Network Access Point (NAP) policies. Accordingly, it may be possible that the cloud customer exfiltrate data to and/or from the restricted customer sections through the service gateways and the services provided by a non-cloud provider. Hence, in an example, one or more restriction policies (e.g., network restriction policies, access restrictions policies, etc.) may be enforced to restrict access to a pre-agreed limited and trusted (e.g., trusted by the assurance administrator) set of services provided by non-cloud providers.

In an example, the restricting assurance administrator section, one or more service tenancies provided by the cloud environment, and/or the assurance administrator may set upper limits on one or more operations to be performed by cloud resources within the restricted customer sections and/or one or more resources or IP addresses accessed from the restricted customer section. Merely as an example, a maximum number of public endpoints that the restricted customer section may have access to is limited by a corresponding limit parameter of the limit restrictions. Other examples of limit restrictions are also described below in further detail.

In an example, due to lack of trust between the assurance administrator and the cloud customer, the assurance administrator may impose restrictions on secure shell (SSH) sessions established by a cloud resource of the restricted customer sections. In an example, due to lack of trust between the assurance administrator and the cloud customer, any such SSH sessions (e.g., in which a restricted customer section participates) may be monitored and/or recorded, or may even be prohibited, as will be described below in further detail.

Various other restrictions policies are also enforced on the restricted customer section, each of which will be described below in further detail.

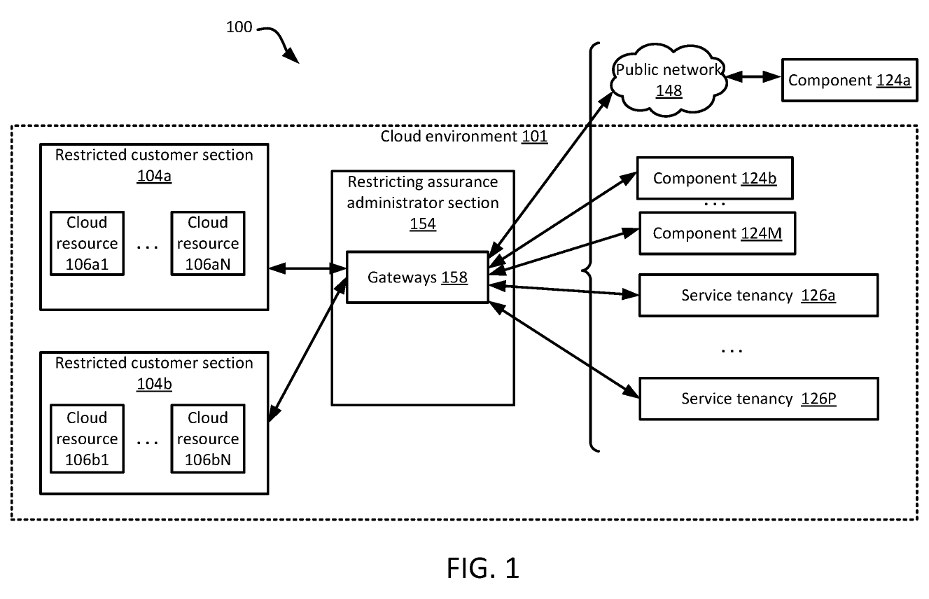

FIG. 1 illustrates a block diagram of a system 100 including a cloud environment 101, wherein the cloud environment 101 comprises one or more customer sections 104a, 104b, wherein a restricting section 154 at least in part restricts operations of the customer sections 104a, 104b. The customer sections 104a, 104b are being restricted, and hence, also referred to herein as restricted customer sections 104a, 104b. For similar reasons, the section 154 is also referred to herein as a restricting section 154. The restricting section 154 is also referred to herein as a restricting assurance administrator section 154, reasons for which are described below in detail.

As described above, for purposes of this disclosure and unless otherwise stated, a “section” of a cloud environment refers to (i) either a tenancy of the cloud environment, or (ii) a compartment within a tenancy. Thus, a section may be a compartment or a tenancy. A section of the cloud environment may be rented to a cloud customer. A “customer section,” for purposes of this disclosure and unless otherwise stated, refers to a tenancy, or a compartment within a tenancy, which is rented to a cloud customer, e.g., by a provider of the cloud environment 101. Thus, for example, each of the restricted customer sections 104a, 104b can be a customer tenancy rented out to a cloud customer, or a compartment within a customer tenancy rented out to the cloud customer. The restricted customer sections 104a, 104b may be rented out to different cloud customers, or may be rented out to a same cloud customer.

Similarly, the restricting assurance administrator section 154 may be a tenancy that is rented out to the assurance administrator. Note that in an example, the assurance administrator and the cloud provider may be the same. In such an example, the restricting assurance administrator section 154 may be a tenancy of the cloud provider.

In a typical scenario, a cloud customer renting a customer tenancy within a cloud environment may use cloud resources within the customer tenancy, independent of any major oversight from a provider of the cloud environment or any third-party oversight. For example, the cloud customer can ingress and/or egress data from and/or to a customer section (such as a customer tenancy or a customer compartment), with minimal or no oversight from the provider of the cloud environment or from another third party.

However, in the context of software assurance described herein, an additional role of an assurance administrator is added into the picture. The assurance administrator may or may not be the same as the cloud provider. In an example, the assurance administrator acts as a “trusted technology provider” (TTP). With regard to the subject disclosure, in an example, the assurance administrator has a monitoring role over a manner in which the cloud customer is using cloud resources within a customer section. Merely as an example, the assurance administrator may want to at least in part monitor traffic going to, or coming out of the customer section. In another example, the assurance administrator may want to monitor and restrict types of API (application programming interface) requests made from and/or to a customer section. Other types of restrictions imposed on a customer section may also be possible, as described below. For example, the assurance administrator may want to ensure that the cloud customer is compliant with guidelines mutually agreed between the cloud customer and the assurance administrator, although other example monitoring use cases (such as reasons behind such monitoring) may also be possible. In an example, the assurance administrator may be tasked by a government regulatory agency to monitor the customer section, e.g., to ensure that the customer section adheres to regulatory guidelines established by the government regulatory agency. In another example, the customer section may deal with high security and/or sensitive information, such as when the customer section is rented out to a financial institution or a health care organization (where privacy of confidential patient record is important), and in such cases, the cloud customer and/or a regulatory authority may appoint the assurance administrator to monitor and restrict one or more operations of the customer section. Accordingly, the assurance administrator operates the restricting assurance administrator section 154, to at least in part restrict one or more operations of the restricted customer sections 104a, 104b.

In an example, the restricting assurance administrator section 154 comprises one or more gateways 158. In an example, at least some or all the traffic to and/or from the restricted customer sections 104a, 104b are transmitted through the gateways 158. In an example, because the gateways 158 are operated by the assurance administrator, the assurance administrator configures the gateways 158, e.g., to impose one or more restrictions on the restricted customer sections 104a, 104b, as described below in further detail.

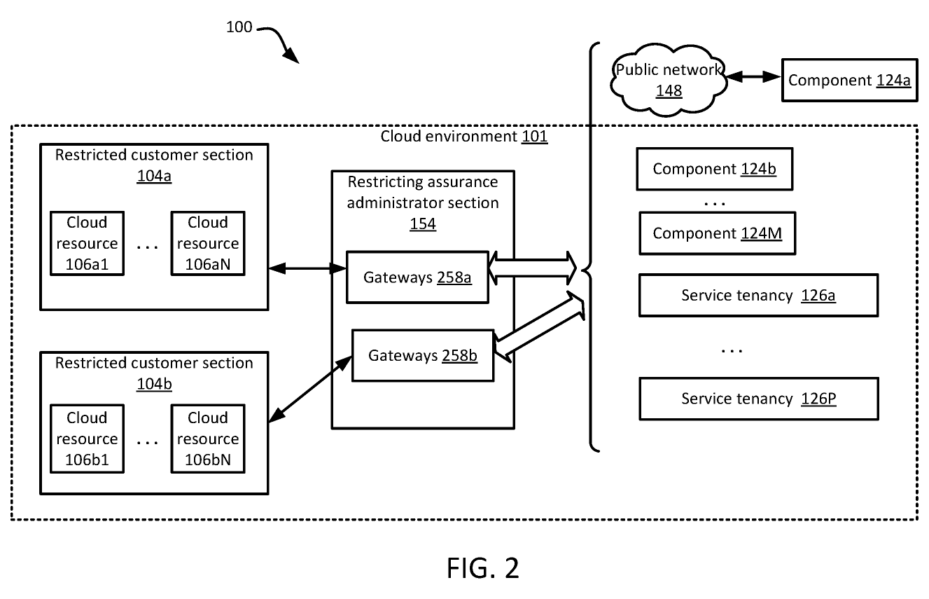

In FIG. 1, a same or common set of gateways 158 control traffic to and/or from the restricted customer sections 104a, 104b. However, two different sets of gateways may control traffic to and/or from the two restricted customer sections 104a, 104b. FIG. 2 illustrates a plurality of sets of gateways 258a, 258b within a restricting assurance administrator section 154 controlling traffic to and/or from a corresponding plurality of restricted customer sections 104a, 104b. For example, gateways 258a control traffic to and/or from the restricted customer section 104a, and gateways 258b control traffic to and/or from the restricted customer section 104b. Although in at least some of the subsequent figures, common gateways are illustrated for multiple restricted customer sections, each restricted customer section may have its corresponding dedicated one or more gateways, as illustrated in FIG. 2.

Referring again to FIG. 1, the restricted customer sections 104a, 104b communicate, through the gateways 158, with a plurality of components 124a, 124b, …, 124M, and/or one or more service tenancies 126a, …, 126P. At least one or more of the components 124a, 124b, …, 124M (such as the component 124a) are outside the cloud environment 101, such as the cloud customer’s on-premise computing resources, websites and Internet Protocol (IP) addresses, end user devices, etc. In an example, such off-cloud component(s) 124a are accessible to the restricted customer sections 104a, 104b through the gateways 158 and a public network 148 (such as the Internet).

The components 124b, …, 124M may be any appropriate cloud resources within the cloud environment 101, such as compute instances, cloud network resources, cloud memory resources, and/or other cloud resources within the cloud environment 101. The service tenancy 126a, …, 126P are tenancies operated by the provider of the cloud environment 101 and/or the assurance administrator, e.g., to provide one or more cloud services to the restricted customer sections 104a, 104b.

In an example, each restricted customer section 104a, 104b comprises a plurality of cloud resources 106, such as cloud resources 106a1, …, 106aN within the restricted customer section 104a, and cloud resources 106b1, …, 106bN within the restricted customer section 104b. In an example, the cloud resources 106 may be compute instances, cloud network resources, cloud memory resources, and/or other types of cloud resources deployed within the restricted customer sections 104a, 104b.

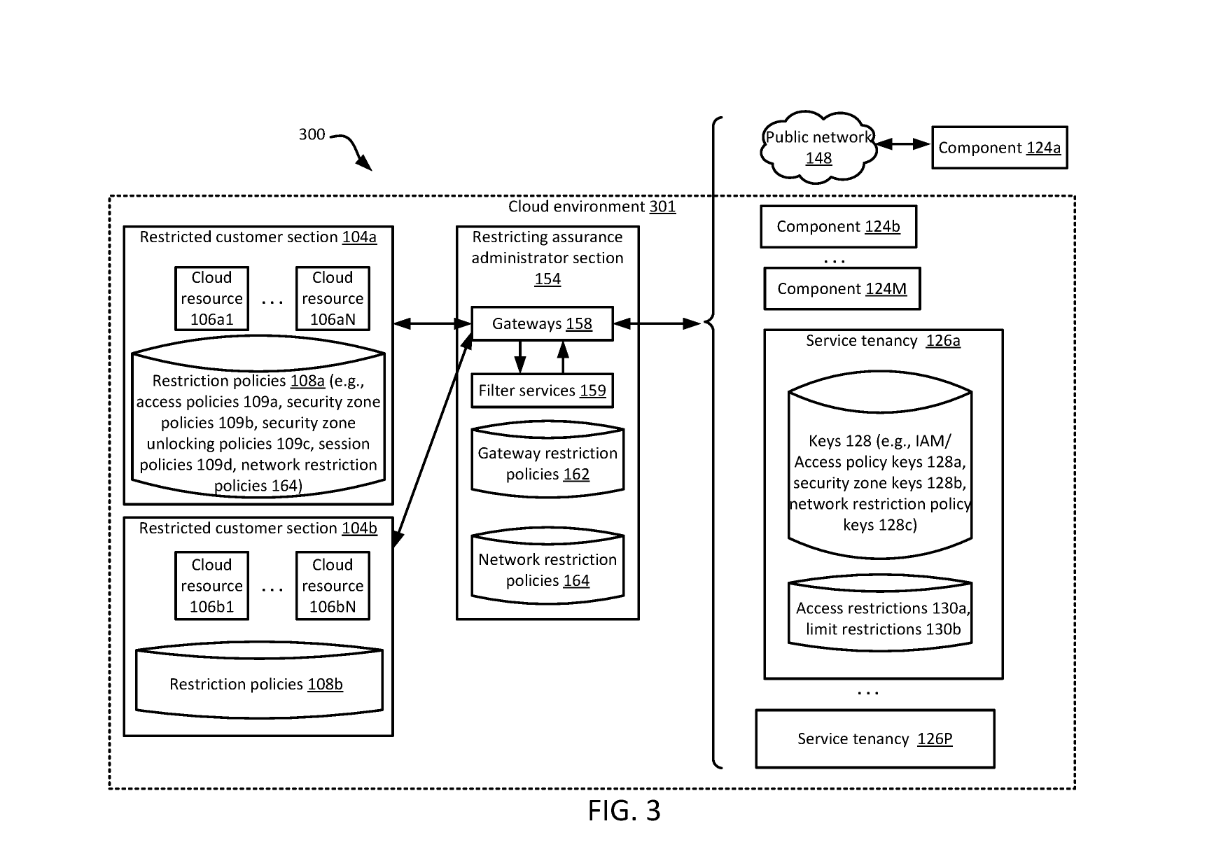

FIG. 3 illustrates a block diagram of a system 300 including a cloud environment 301, wherein the cloud environment 301 comprises one or more restricted customer sections 104a, 104b, where a restricting assurance administrator 154 at least in part restricts operations of the restricted customer sections 104a, 104b, and wherein the cloud environment 301 further includes (i) restriction policies 108 stored within the restricted customer sections 104a, 104b, and/or (ii) keys 128 for unlocking one or more restriction policies 108, the keys 128 stored within one or more service tenancies 126a, …, 126P of the cloud environment 301.

Similar components in the system 100 of FIGS. 1 and 2 and the system 300 of FIG. 3 are labelled using similar labels. For example, the system 300 of FIG. 3 comprises two restricted customer sections 104a, 104b, although another appropriate number of restricted customer section(s) may also be possible. As also described above, each restricted customer section 104 is a restricted customer tenancy, or a restricted customer compartment within a customer tenancy.

The restricting assurance administrator section 154 similarly is a restricting assurance administrator tenancy, or a restricting assurance administrator compartment within an assurance administrator tenancy (such as a tenancy operated by the assurance administrator), in an example. Furthermore, communication to and/or from the restricted customer sections 104a, 104b are through the gateways 158, although the gateway 158 may comprise two sets of gateways (such as a first set for communication to and/or from the restricted customer section 104a, and a second set for communication to and/or from the restricted customer section 104b), as described above with respect to FIG. 2.

In an example, a restricted customer section 104 includes data of the cloud customers to whom the restricted customer section 104 is rented. Merely as an example, a restricted customer section 104 stores source code developed by the cloud customer, e.g., for a mobile application of the cloud customer and/or source code for supporting a website of the cloud customer. In another example, a restricted customer section 104 includes a software package for a mobile application and/or a software package for supporting a website of the cloud customer. In yet another example, a restricted customer section 104 includes user data, such as data of one or more users who are signed up with the cloud customer, to receive one or more cloud-based services from the cloud customer. In yet another example, a restricted customer section 104 includes content (such as audios, videos, data, etc.) that the cloud customer is to offer to one or more users for consumption. In a further example, a restricted customer section 104 includes any other data and/or code of the cloud customer.

In an example, in FIG. 3, there are multiple layers of restrictions on the restricted customer sections 104a, 104b. For example, the restricting assurance administrator section 154 comprises, in addition to the gateways 158, a plurality of filter services 159. A filter service 159 is configured to inspect traffic destined for, or originating from, a cloud resource 106 of any of the restricted customer sections 104a, 104b. The filter services 159 are described in further detail in co-pending patent application entitled “Filter chain for software assurance in a cloud environment,” Application No. ____, filed ___ (Attorney docket number 50OR376US), which is incorporated herein in its entirety.

In an example, the filter services 159 perform software assurance on at least a section of, or all of, the traffic destined for, or originating from, cloud resources 106 of any of the restricted customer sections 104a, 104b. For example, the filter services 159 analyze the traffic for anomalous or malicious data, e.g., in real or near-real time. In an example, if a payload with such anomalous or malicious data is detected by the filter services 159, the gateways 158 deny passage of such a payload to its intended destination. In another example, if a payload with such anomalous issue is detected by the filter services 159, the filter services 159 causes modification of the payload to resolve the anomalous issue, and then the gateways 158 allows passage of the modified payload to its intended destination. On the other hand, in an example, if the filter services 159 fail to detect any anomalous issues with the payload, the filter services 159 causes the gateways 158 to allow passage of the payload to its intended destination.

In an example, to ensure that traffic to and/or from the restricted customer sections 104a, 104b transits via the gateways 158, the assurance administrator imposes restrictions on the restricted customer sections 104a, 104b. For example, restrictions are placed on operations that can possibly result in data exfiltration to and/or from the restricted customer sections 104a, 104b by bypassing the gateways 158. For example, multiple “rings of controls” are imposed around the restricted customer sections 104a, 104b, resulting in implementation of software assurance of the restricted customer sections 104a, 104b through the gateway 158 and the filter services 159.

In an example, the restricting assurance administrator section 154 comprises a storage repository storing gateway restriction policies 162. The gateway restriction policies 162 dictate one or more policies for operation of the gateways 158. For example, the gateway restriction policies 162 dictate which cloud resource 106 can establish a connection, through the gateways 158, to which resource within or external to the cloud environment 301. Merely as an example, the gateway restriction policies 162 may allow the cloud resource 106a1 to communicate with the component 124a over the public network 148 (such as the Internet), where the component 124a may be a computing resource within in the cloud customer’s local on-premise network. However, the gateway restriction policies 162 may disallow the cloud resource 106a1 to communicate with other resources outside the cloud environment 301. In an example, the gateway restriction policies 162 may be part on an Identity and Access Management (IAM) policies maintained by the provider of the cloud environment 301, or may be different from the IAM policies.

In an example, the restricting assurance administrator section 154 further comprises a storage repository storing network restriction policies 164. The network restriction policies 164 dictate one or more policies for setting up network resources by cloud resources 106 within the restricted customer sections 104a, 104b. For example, the network restriction policies 164 implements network-based access control (NBAC) restrictions on the restricted customer sections 104a, 104b.

In an example, the network restriction policies 164 ensures that external access to a restricted customer section 104 is through a restricting assurance administrator section 154, and that the cloud customer cannot transmit data to and/or from any of the restricted customer sections 104a, 104b by bypassing the restricting assurance administrator section 154. The network restriction policies 164 ensure that access to cloud resources 106 within a restricted customer section 104 can be (i) from one or more other cloud resources 106 within the same restricted customer section 104 or (ii) through the restricting assurance administrator section 154, unless explicitly permitted by one or more other rules described herein. Thus, in an example, a cloud resources 106a1 within a restricted customer section 104a can access and communicate data with another cloud resources 106aN within the same restricted customer section 104a, by bypassing the gateways 158. However, the cloud resource 106a1 within the restricted section 104a can access and communicate data with external components and services 124a, …, 124M, 126a, …, 126P through (such as only through) the gateways 158 of the restricting assurance administrator section 154.

For example, the network restriction policies 164 ensure that access to cloud resources 106 within the restricted section 104 from outside the restricted section 104 is not permitted, unless such a connection is through the restricting assurance administrator section 154. Thus, the network restriction policies 164 prevent or reduce chances of forming Network Access Point (NAP) ingress or ingress through other network sources to any of the restricted customer sections 104a, 104b. Similarly, in an example, the network restriction policies 164 ensure that access from the cloud resources 106 with a restricted customer section 104 to outside the restricted customer section 104 is not permitted, unless through the restricting assurance administrator section 154. Thus, the network restriction policies 164 prevent NAP egress or egress through other network sources to outside the restricted section 104.

In an example, the network restriction policies 164 prevents or disallows the cloud customer from forming its own one or more gateways allowing traffic flow to and/or from the restricted customer sections 104a, 104b, and ensures traffic flow to and/or from the restricted customer sections 104a, 104b are through the restricting assurance administrator section 154 only. In an example, instead of or in addition to the network restriction policies 164 being stored within the storage repository in the restricting assurance administrator section 154, the network restriction policies 164 may also be stored within a storage repository in one or both the restricted customer sections 104a, 104b, as also illustrated in FIG. 3.

In an example, various restriction policies within the cloud environment 301 (such as the network restriction policies 164, and one or more other policies described below) may be “locked”. For example, because of lack of trust between the assurance administrator and the cloud customer, the assurance administrator may not allow the cloud customer to create, modify, and/or delete such restriction policies. For example, any user and/or administrator of the restricted customer sections 104a, 104b and/or personnel of the cloud customer may not be permitted to create, modify, and/or delete any such restriction policies. Only pre-approved users and/or administrators of the assurance administrator may be permitted to create, modify, and/or delete such restriction policies. Accordingly, locks may be implemented within the cloud environment 301, where the locks may disallow any user and/or administrator of the restricted customer sections 104a, 104b and/or personnel of the cloud customer from creating, modifying, and/or deleting such restriction policies. The locks may, however, allow one or more users or administrators of the assurance administrator to create, modify, and/or delete such restriction policies.

In an example, keys 128 to such locks may be stored in one or more service tenancies 126, such as within a storage repository in the service tenancy 126a. Different examples of locks and corresponding keys 128 are illustrated in FIG. 3, such as access policy keys 128a, security zone keys 128b, network restriction policy keys 128c, as will be described below in further detail. Although all these keys 128 are illustrated in FIG. 3 to be stored in a single service tenancy 126a, the keys 128 may all be stored in one single service tenancy, or may be distributed among multiple service tenancies.

In an example, each key 128 may be in the form of an encryption key stored within a service tenancy 126. For example, a key corresponding to a lock is used to create, modify, and/or delete one or more, or all of the associated restriction policies.

Merely as an example, the network restriction policy keys 128c may include an encryption key that may be usable to create, modify, and/or delete one or more, or all of the associated network restriction policies 164. Similarly, the security zone keys 128b may include an encryption key that may be usable to create, modify, bypass, and/or delete one or more, or all of associated security zone policies 109b that are described below.

In an example, a key 128 associated with a corresponding lock may be a cryptographic key or a session token that may be usable to create, modify, bypass, and/or delete corresponding one or more, or all of the restriction policies. Thus, any request to create, modify, bypass, and/or delete a restriction policy (such as the network restriction policies 164) may be accompanied by the cryptographic key or session token associated with the corresponding lock(s) (such as the network restriction policy keys 128c). For example, any request to create, modify, bypass, and/or delete the network restriction policies 164 may be conditioned upon having an accompanying cryptographic key (or session token) and/or based on a role of the requester issuing the request (where the role of the requester is described below).

However, in another example, in addition to (or instead of) a key, an authorized user credential (such as a user principal) of the assurance administrator may be used to create, modify, bypass, and/or delete one or more restriction policies. For example, only prespecified group of administrators and/or a certain group of users of the assurance administrator may have privileges to temporarily unlock, create, modify, bypass, and/or delete a restriction policy. For example, the network restriction policy keys 128c may comprise a user credential (also referred to as a “user principal”). The user credential is usable to authenticate a personnel or administrator of the assurance administrator to an Identity and Access Management (IAM) service of the cloud environment 301. The user credential is assigned to an assurance administrator personnel, such as a user belonging to an administrator group or a certain user group of the assurance administrator. A user having the user credential can be authenticated by the IAM, and such authenticated user may be authorized by the IAM (or another service of the cloud environment 301) to temporarily unlock, bypass, create, modify, and/or delete the corresponding restriction policies (such as the network restriction policy locks). In another example, the user having the user credential may temporarily unlock, create, modify, and/or delete the restriction policies using a corresponding key.

In an example, the cloud environment 301 implements one or more security zone policies 109a. The security zone policies 109a are an example of restriction policies 108 stored within a storage repository in a corresponding restricted customer section 104. For example, the restricted customer section 104a may include a storage repository storing the one or more restriction policies 108a comprising the corresponding security zone policies 109a; the restricted customer section 104b may include a storage repository storing one or more restriction policies 108b comprising corresponding security zone policies, and so on.

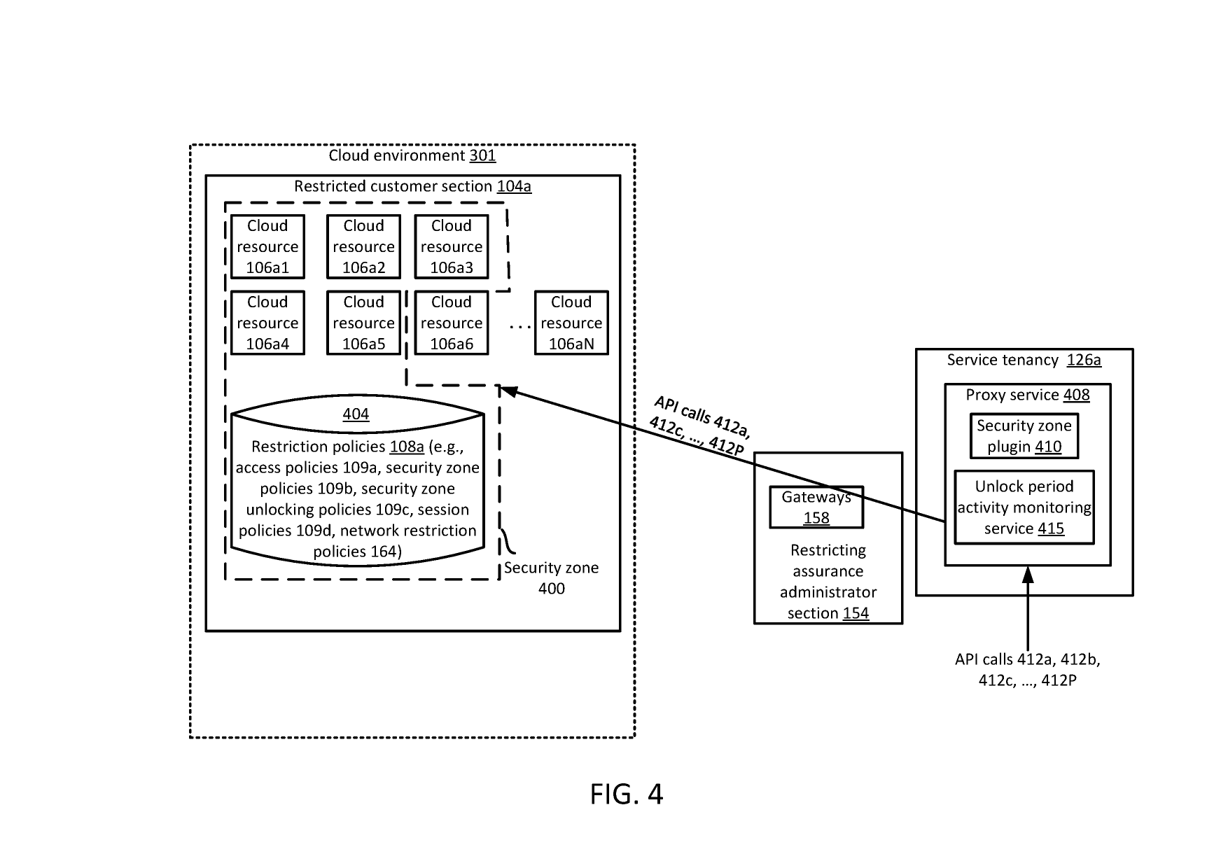

In an example, the assurance administrator causes implementation of a security zone within a customer section, such as within the restricted customer section 104a and/or within the restricted customer section 104b, where cloud resources within a security zone of the restricted customer section 104 have to adhere to a plurality of security zone policies. The security zone within a restricted customer section 104 is a logical partitioning within the customer section, where cloud resources within the security zone are exposed to the corresponding security zone policies 109b of the security zone. In an example, a security zone may encompass an entirety of a customer tenancy, or a part (such as one or more compartments) of the customer tenancy. For example, FIG. 4 illustrates a security zone 400 established within a restricted customer section 104a of the cloud environment 301. The security zone 400 encompasses cloud resources 106a1, …, 106a5, although fewer or more cloud resources of the restricted customer section 104a may be included within the security zone 400. In an example, the cloud resources within the security zone 400 also includes a storage repository 404 storing the plurality of restriction policies 108a, including security zone policies 109b associated with the security zone 400. In an example, a security zone policy 109b is a denial policy, which denies an incoming API call destined for a cloud resource 106 within the security zone 400, e.g., if the API call violates the security zone policy.

In an example and as illustrated in FIG. 4, the cloud environment 301 also comprises a service tenancy 126a, which is operated by a provider of the cloud environment and/or by the assurance administrator. In any case, the service tenancy 126a is not operated by the cloud customer, to whom the restricted customer section 104a is rented. In an example, the service tenancy 126a executes a proxy service 408 that has access to the storage repository 404 storing the security zone policies 109b.

In an example, the proxy service 408 facilitates in enforcing the security zone 400 within the restricted customer section 104a. For example, the proxy service 408 intercepts API calls 412a, …, 412P made to one or more of the cloud resources 106a1, …, 106a5 within the security zone 400 of the restricted customer section 104a. Thus, any API call destined for a cloud resource within the security zone 400 has to pass through the proxy service 408.

In an example, the proxy service 408 includes a security zone plugin 410. The security zone plugin 410 determines if an API call (which was destined for a cloud resource within the security zone 400) matches with any of the security zone policies 109b. If the API call matches with at least a security zone policy 109b, the proxy service 408 blocks passage of the API call to its intended destination within the security zone 400. On the other hand, if the API call does not match with any of the security zone policies 109b, the proxy service 408 allows passage of the API call to its intended destination within the security zone.

Thus, in the example of FIG. 4, the API call 412b is blocked by the proxy service 408. The remaining API calls 412a, 412c, …, 412P are allowed passage to corresponding one or more cloud resources 106a1, …, 106a5 within the security zone 400 through the gateway 158 of the restricting assurance administrator section 154, as illustrated in FIG. 4.

In an example, the security zone plugin 410 is developed, maintained, operated, and/or configured by the assurance administrator. For example, the cloud customer, to whom the restricted customer section 104a is rented out, may not have any control on a configuration and/or operation of the security zone plugin 410.

In an example, each API call has a corresponding API call type and a corresponding API call parameter. Similarly, each security zone policy has a predefined API call type and one or more predefined API call parameters. In an example, once the proxy service 408 receives an API call destined for a cloud resource (e.g., cloud resource 106a1) within the security zone 400, the security zone plugin 410 determines an API call type of the API call and the corresponding API parameter of the API call. The security zone plugin 410 then compares the API call type of the API call and the corresponding API parameter of the API call to the predefined API call types and predefined API call parameters of the security zone policies 109b. If the API call type of the API call and the API parameter of the API call match with any of those mentioned in one of the security zone policies 109b, the proxy service 408 denies or blocks the API call. On the other hand, if the API call does not match with any of the security zone policies 109b, the proxy service 408 allows the API call to be transmitted to its intended destination, which may be a cloud resource 106 within the security zone 400.

In an example, an authorized user credential of the assurance administrator may be used to create, modify, bypass, and/or delete the security zone policies 109b (e.g., using the security zone keys 128b, see FIG. 3). For example, only prespecified group of administrators and/or a prespecified group of users of an assurance administrator tenancy may have privileges to temporarily unlock, create, modify, and/or delete the security zone policies 109b. Users or administrators of the restricted customer section 104a (or 104b) may not be able to unlock, create, modify, and/or delete the security zone policies 109b.

In an example, the security zone policies 109b provide the assurance administrator some degree of control over activities within the restricted customer sections 104a, 104b. For example, security zone policies 109b may deny creation of certain types of cloud resources by the cloud customer (e.g., creation of one or more gateways, to bypass the gateways 158 of the assurance administrator, etc.), creation of IAM policies, limit creating compute instances only with software assurance approved operating system (OS) images, etc., without explicit knowledge and/or permission by the assurance administrator. Security zones and associated security zone policies are described in further detail in co-pending US patent application 18/967,203, filed December 3, 2024, entitled “SECURITY ZONES WITHIN A CLOUD ENVIRONMENT,” which is incorporated by reference herein in its entirety.

As described, due to the security zone policies 109b implemented by the security zone plugin 410, API calls destined for the cloud resources and violating one or more security zone policies 109b are selectively blocked by the security zone plugin 410 and the proxy service 408. However, in an example, there may be legitimate scenarios where the cloud customer may want to perform activities that are explicitly denied in the security zone policies 109b. However, the cloud customer, to whom the restricted customer sections 104a, 104b are rented, does not have privileges to bypass, modify, configure, or delete any security zone policy. Such privileges are accorded to personnel of the assurance administrator. Accordingly, in an example, bypassing of a security zone policy (which is also referred to as unlocking of the security zone policy) is performed jointly or collaboratively between the cloud customer and the assurance administrator.

For example, the cloud customer and the assurance administrator may collaborate to temporarily unlock one or more of the security zone policies, e.g., using the security zone keys 128b). This way, in an example, the assurance administrator is aware of activities performed by the cloud customer (such as API calls received by the cloud resources 106a1, …, 106a5 within the security zone 400), while one or more of the security zone policies 109b are unlocked, such as temporarily lifted or bypassed. For example, the cloud customer initially requests the assurance administrator to temporarily unlock one or more security zone policies 109b. The assurance administrator reviews and may approve the request for temporarily unlocking the one or more security zone policies. The assurance administrator unlocks one or more security zone policies, e.g., using the security zone keys 128b (e.g., which may be encryption keys, session tokens, and/or user principals, as described above in further detail). In an example, when one or more security zone policies are unlocked, the security zone plugin 410 and/or the proxy service 408 does not implement the security zone policies 109b (e.g., the security zone policies are bypassed). For example, during the unlocked state, the security zone plugin 410 may still check for API calls for violation of such one or more security zone policies, but nonetheless the proxy service 408 allows such API calls that should have been otherwise blocked due to the one or more security zone policies. In another example, during the unlocked state, the security zone plugin 410 may not even check the API calls for violation of the one or more security zone policies 109b. In an example, subsequent to unlocking the security zone policies and after the cloud customer has performed target operations during the unlocked state of the security zone policies 109b, the security zone policies 109b may be relocked.

However, there may be some degree of lack of trust between the cloud customer and the assurance administrator. For example, the assurance administrator may want to ensure that during the unlocked state of the security zone policies 109b, the cloud customer does not take undue advantage of the unlocked state. Thus, in an example, the assurance administrator may want to monitor and/or log API calls allowed by the proxy service 408 during the unlocked state of the security zone policies 109b.

Accordingly, in an example, the assurance administrator causes an unlock period activity monitoring service 415 to operate within the proxy service 408, as illustrated in FIG. 4. In an example, the unlock period activity monitoring service 415 operates in accordance with security zone unlocking policies 109c (e.g., stored in storage repositories within restricted customer section 104a and/or 104b, see FIG. 3). The unlock period activity monitoring service 415 monitors and/or selectively logs API calls, e.g., when one or more security zone policies are unlocked and remain unlocked. Monitoring of API calls during an unlocked state of the security zone policies 109b, and locking and unlocking of security zone policies 109b are described in further detail in US patent application 18/967,210, filed December 3, 2024, entitled “UNLOCKING AND RELOCKING OF SECURITY POLICIES WITHIN A CLOUD ENVIRONMENT,” which is incorporated by reference herein in its entirety.

Referring again to FIG. 3, the restriction policies 108a within the restricted customer section 104a (and similarly the restrictions policies 108b within the restricted customer section 104b) further include access policies 109a, which is an example of restriction policies 108a. In an example, the access policies 109a are IAM policies described above. Access policies 109a are enforced for the restricted customer sections 104a, 104b. For example, the access policies 109a are stored in storage repositories within the restricted customer sections 104a, 104b. In an example, personnel of the cloud customer (such as users and/or administrators of the cloud customer) may not be able to alter or delete the access policies 109a, as such access policies 109a are locked, and can be unlocked using the access policy keys 128a stored within a service tenancy 126a. Similar to the other keys 128, personnel of the assurance administrator (such as users and/or administrators of the assurance administrator) have privileges to use the access policy keys 128a unlock, bypass, create, modify, and/or delete the access policies 109a.

In an example, the access policies 109a are directed towards denying unauthorized access to network sources, and enforces network sources specified in one or more policies for network restriction policies 164. In an example, the IAM, based on the access policies 109a, verifies an identity of a requester from which a request is received (where the request originates for, or is destined for a restricted component), and determines whether the requester is authorized to transmit the request. Access policies 109a dictates who can access which resources within the cloud environment 301, and how. For example, access is granted at a group and/or a compartment level, or at a tenancy level. Thus, an access policy 109a may provide a group of cloud resources a specific type of access within a specific section (such as within a compartment, or within a tenancy). For example, a group of cloud resources (e.g., cloud resources within a logical unit, such as a restricted customer section 104) may be given access to one or more cloud resources and/or one or more cloud services.

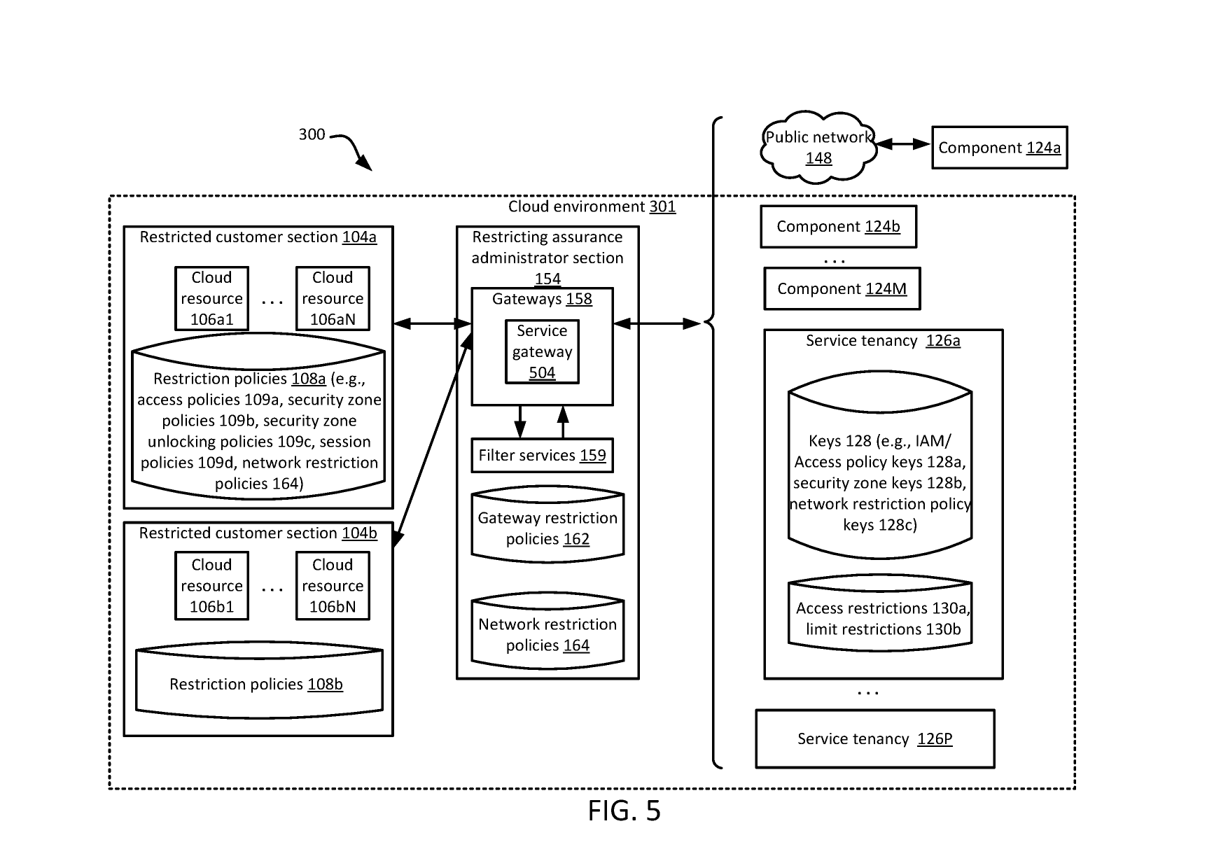

In an example, access by one or more cloud resources 106a1, …, 106aN, 106b1, …, 106bN within any of the restricted customer sections 104a, 104b to one or more services provided by the cloud provider of the cloud environment 301 and/or by non-cloud providers may be restricted within the cloud environment 301. For example, FIG. 5 illustrates one or more service gateways (SGW) 504 within the restricting assurance administrator section 154, where the service gateways (SGW) 504 allow access to services provided by the provider of the cloud environment 301 (such as a service provided by the service tenancy 126a) and/or provided by off-cloud services (such as a service provided by the component 124a). The service gateways 504 may be included within the restricting assurance administrator section 154, such as those included in the gateways 158. In an example, services provided by non-cloud provider may not support access policies 109a, network restriction policies 164, and/or Network Access Point (NAP) policies. Accordingly, it may be possible that the cloud customer exfiltrate data to and/or from the restricted customer sections 104a and/or 104b through the service gateways 504 and the services provided by a non-cloud provider. Hence, one or more restriction policies 108a (e.g., the network restriction policies 164, access restrictions policies 130 stored within the service tenancy 126a, etc.) are enforced to restrict access to a pre-agreed limited and trusted (e.g., trusted by the assurance administrator) set of services provided by non-cloud providers, such as one or more services provided by the off-cloud component 124a.

In an example, the restricting assurance administrator section 154, the one or more service tenancies 126a, …, 126P and/or the assurance administrator may set upper limits for one or more operations to be performed by cloud resources 106 within the restricted customer sections 104a, 104b. For example, limit restrictions 130b (which may be stored in a storage repository within a service tenancy 126a, or within a restricting customer section 104) may store such limit or quota restrictions. Merely as an example, a maximum number of public endpoints that the restricted customer sections 104a, 104b may have access to is limited by a corresponding limit parameter of the limit restrictions 130b. Other examples in which such limit restrictions 130b may be placed may be a maximum number of cloud shells associated with a restricted section 140, a maximum number of public IP addresses assigned to one or more cloud resources of a restricted customer section 104, a maximum number of public IP addresses that can be accessed by a restricted customer section 104, a maximum number of private endpoints associated with a restricted customer section 104, etc. In an example, each such limit parameter may be set to zero, or one, or two, or another appropriate number that is pre-agreed between the cloud customer and the assurance administrator.

In an example, due to lack of trust between the assurance administrator and the cloud customer, the assurance administrator may impose restrictions on secure shell (SSH) sessions established by a cloud resource of the restricted customer sections 104a and/or 104b. SSH is a network protocol that allows users to remotely access and communicate over an unsecured network. In an example, due to lack of trust between the assurance administrator and the cloud customer, any such SSH sessions (e.g., in which a restricted customer section 104 participates) may be monitored and/or recorded, or may even be prohibited. In an example, creation of zero trust bastion (ZTB) within a restricted customer section 104 may be denied. ZTBs, in an example, may be created in a section operated by (or under control of) the assurance administrator. If required, personnel of the cloud customer may create ZTB sessions in such ZTBs. In an example, session activities of such ZTB sessions or any SSH session may be monitored and/or recorded, and may be shared with the cloud customer and the assurance administrator personnel. In an example, access restrictions 130a within a service tenancy may ensure adherences to such restrictions placed on SSH sessions and/or ZTB sessions. In another example, session policies 109d within storage repositories of the restricted customer sections 104a and/or 104b may ensure adherences to such restrictions placed on SSH sessions and/or ZTB sessions.

For a typical cloud customer, administrators of a customer section are assigned administrative privileges, and corresponding usernames and passwords for accessing such administrative privileges are provided to the cloud customer. However, in an example, for the restricted customer sections 104a, 104b, passwords for administrative privileges may not be shared with personnel of the cloud customer. In another example, password for the default administrator account of the customer sections 104a, 104b is reset by personnel of the assurance administrator, rendering such a password for use only as break-glass (such as for emergency measures only) during emergency use cases.

In an example, one or more automated workflows to be performed by the restricted customer sections 104a and/or 104b may be preapproved by the assurance administrator personnel. Such preapproved workflows may otherwise be denied by one or more security zone rules and/or access control rules. Examples of such preapproved workflows may include one or more of adding IAM policies, creating local peering gateways (LPGs), etc. LPG is a connection point that allows resources in a virtual cloud network (VCN) to communicate with resources in other VCNs in the same region.

FIG. 6 illustrates a layered approach to implementing a ring of controls on an ingress request 604 to a cloud resource 106 (such as cloud resource 106a1) of a restricted customer section 104a of the cloud environment 301. The request 604 may be from any compute resource either within or outside the cloud environment 301. The request 604 traverses through a plurality of restrictions policies, and can reach its intended destination (e.g., the cloud resource 106a1) if the request does not violate any of the restriction policies described above.

For example, for the request 604 to reach the intended destination, the request 604 is checked to ensure that the request 604 does not violate the gateway restriction policies 162, the network restriction policies 164 (such as network restriction policies for ingress request), security zone policies 109b, access policies 109a, and/or security zone unlocking policies 109c, prior to the request 604 reaching the cloud resource 106a1.

For example, the gateway restriction policies 162 ensures that the request 604 is routed through an approved gateway of an assurance administrator section, such as the gateways 158 of the restricting assurance administrator section 154. The network restriction policies 164 checks to ensure that the request 604 has originated from a network and/or a resource that is allowed to transmit request to the intended destination (e.g., the cloud resource 106a1).

The security zone policies 109b checks to ensure that the request 604 (e.g., if the request 604 is an API request) is allowed to enter a security zone (such as the security zone 400 of FIG. 4) including the intended destination of the request, and that the type of API request does not violate any security zone policies 109b. The access policies 109a check the request 604 to ensure that the originator of the request is authenticated and has access permission to the intended destination of the request 604. The security zone unlocking policies 109c ensure that if the API call is to be blocked by the security zone policies 109b and if the security zone policies 109b are unlocked, then the request 604 is recorded and logged (e.g., by the unlock period activity monitoring service 415 of FIG. 4) while being transmitted during the unlocked state of the security zone policies 109b, in an example.

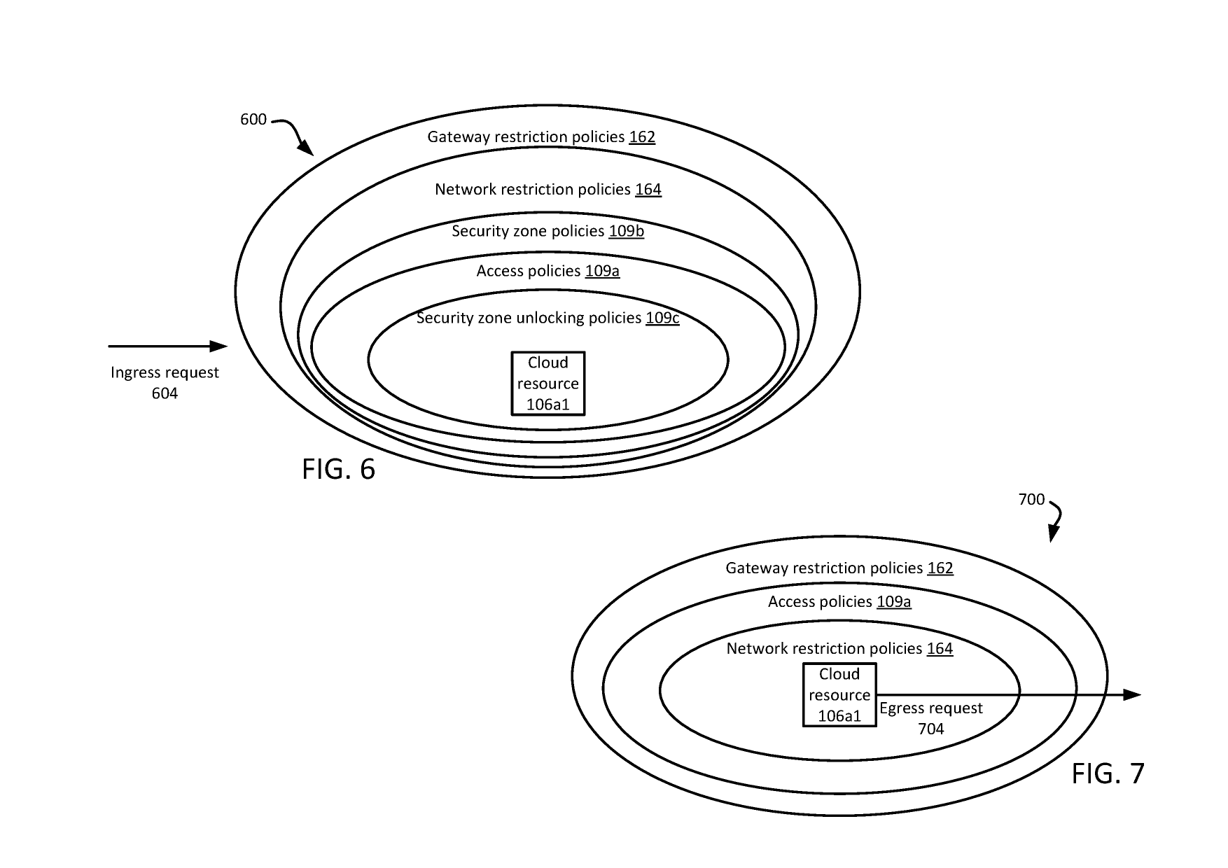

FIG. 7 illustrates a layered approach to implementing a ring of controls on an egress request 704 from a cloud resource 106 (such as cloud resource 106a1) of a restricted customer section 104a of the cloud environment 301. The request 704 may be destined for any compute resource either within or outside the cloud environment 301. The request 704 traverses through a plurality of restriction policies, and can reach its intended destination if the request does not violate any of the restriction policies described above.

For example, for the request 704 to reach the intended destination, the request 704 is checked to ensure that the request 704 does not violate the egress network restriction policies 164, access policies 109a, and/or the gateway restriction policies 162, prior to the request 704 reaching the cloud resource 106a1. For example, the network restriction policies 164 checks to ensure that the request 704 is destined for a network and/or a resource that is allowed to receive a request from the originator of the request 704 (e.g., the cloud resource 106a1). For example, routing rules, security lists, and/or one or more other network restriction policies are checked to ensure compliance.

The access policies 109a check the request to ensure that the originator of the request is authenticated and has access permission to the intended destination of the request 704. The gateway restriction policies 162 ensures that the request 704 is routed through an approved gateway of an assurance administrator section, such as the gateways 158 of the restricting assurance administrator section 154.

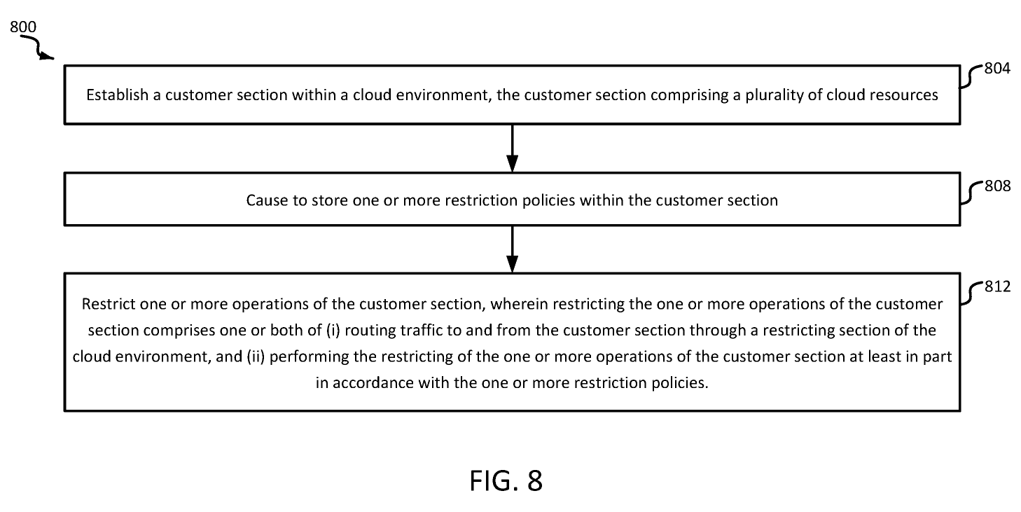

FIG. 8 is a flow diagram depicting a method 800 for restricting operations of a restricted customer section 104 within a cloud environment. The method 800 may be executed within any of the cloud environments described above and with any of the restricted customer sections 104a, 104b.

At 804 of the method 800, a customer section is established within a cloud environment. As illustrated in various figures described above, the customer section includes a plurality of cloud resources. The customer section may be a customer tenancy, or a compartment within the customer tenancy. The customer section is being restricted, and hence is also referred to as a restricted customer section.

At 808, one or more restriction policies are caused to be stored within the customer section. For example, restriction policies 108a such as access policies 109a, security zone policies 109b, security zone unlocking policies 109c, session policies 109d, and/or network restriction policies 164 are stored within the restricted customer section 104a, as described above. In an example, the assurance administrator causes the one or more restriction policies to be stored within the customer section.

At 812, one or more operations of the customer section are restricted. For example, restricting the one or more operations of the customer section comprises one or both of (i) routing traffic to and from the customer section through a restricting section of the cloud environment (such as the restricting assurance administrator section 154 described above), and (ii) performing the restricting of the one or more operations of the customer section at least in part in accordance with the one or more restriction policies, as described above in further detail.

### Computer System Architecture

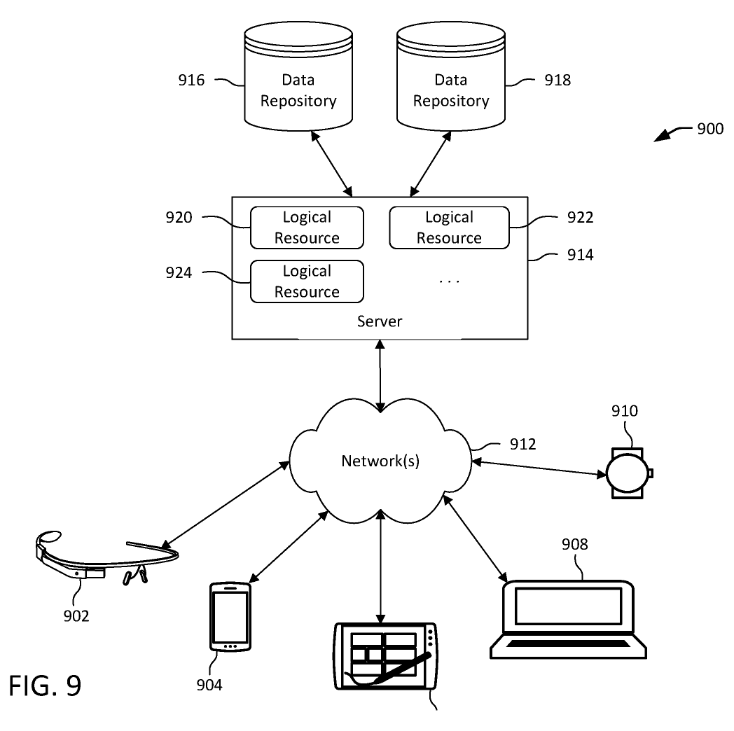

FIG. 9 depicts a simplified diagram of a distributed system 900 for implementing an embodiment. In the illustrated embodiment, distributed system 900 includes one or more client computing devices 902, 904, 906, 908, and/or 910 coupled to a server 914 via one or more communication networks 912. Clients computing devices 902, 904, 906, 908, and/or 910 may be configured to execute one or more applications.

In various aspects, server 914 may be adapted to run one or more services or software applications that enable techniques for enforcing restrictions for software assurance within a cloud environment.

In certain aspects, server 914 may also provide other services or software applications that can include non-virtual and virtual environments. In some aspects, these services may be offered as web-based or cloud services, such as under a Software as a Service (SaaS) model to the users of client computing devices 902, 904, 906, 908, and/or 910. Users operating client computing devices 902, 904, 906, 908, and/or 910 may in turn utilize one or more client applications to interact with server 914 to utilize the services provided by these components.

In the configuration depicted in FIG. 9, server 914 may include one or more components 920, 922 and 924 that implement the functions performed by server 914. These components may include software components that may be executed by one or more processors, hardware components, or combinations thereof. It should be appreciated that various different system configurations are possible, which may be different from distributed system 900. The embodiment shown in FIG. 9 is thus one example of a distributed system for implementing an embodiment system and is not intended to be limiting.

Users may use client computing devices 902, 904, 906, 908, and/or 910 for techniques for enforcing restrictions for software assurance within a cloud environment in accordance with the teachings of this disclosure. A client device may provide an interface that enables a user of the client device to interact with the client device. The client device may also output information to the user via this interface. Although FIG. 9 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 912 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 912 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 914 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 914 can include one or more virtual machines running virtual operating systems, or other computing architectures involving virtualization such as one or more flexible pools of logical storage devices that can be virtualized to maintain virtual storage devices for the server. In various aspects, server 914 may be adapted to run one or more services or software applications that provide the functionality described in the foregoing disclosure.

The computing systems in server 914 may run one or more operating systems including any of those discussed above, as well as any commercially available server operating system. Server 914 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 914 may include one or more applications to analyze and consolidate data feeds and/or event updates received from users of client computing devices 902, 904, 906, 908, and/or 910. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 914 may also include one or more applications to display the data feeds and/or real-time events via one or more display devices of client computing devices 902, 904, 906, 908, and/or 910.

Distributed system 900 may also include one or more data repositories 916, 918. These data repositories may be used to store data and other information in certain aspects. For example, one or more of the data repositories 916, 918 may be used to store information for techniques for enforcing restrictions for software assurance within a cloud environment. Data repositories 916, 918 may reside in a variety of locations. For example, a data repository used by server 914 may be local to server 914 or may be remote from server 914 and in communication with server 914 via a network-based or dedicated connection. Data repositories 916, 918 may be of different types. In certain aspects, a data repository used by server 914 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 916, 918 may also be used by applications to store application data. The data repositories used by applications may be of different types such as, for example, a key-value store repository, an object store repository, or a general storage repository supported by a file system.

In one embodiment, server 914 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

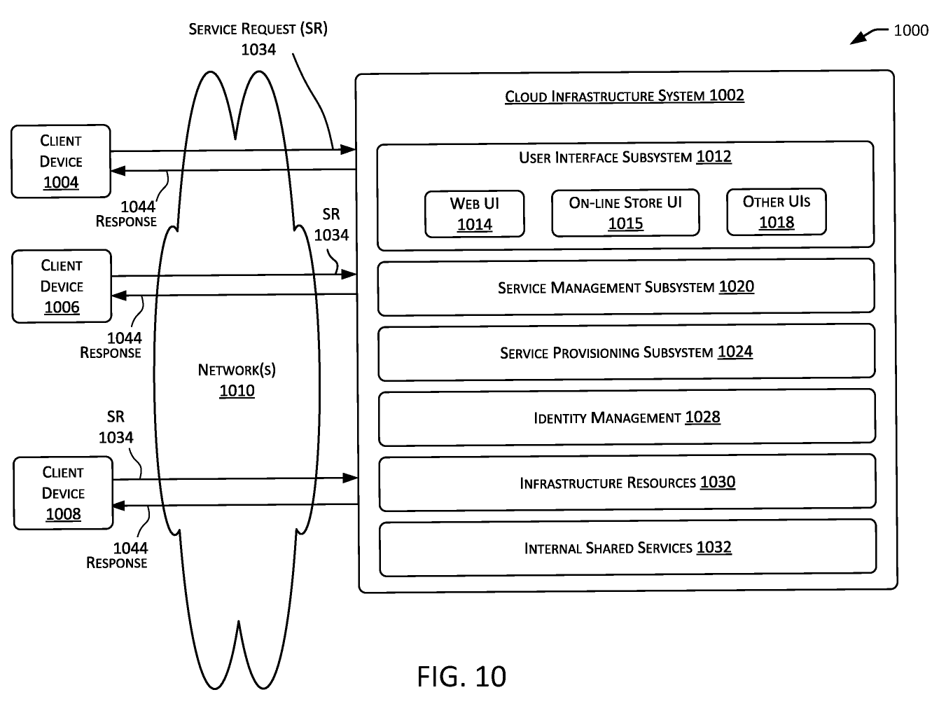

FIG. 10 is a simplified block diagram of a cloud-based system environment in which techniques for enforcing restrictions for software assurance within a cloud environment are disclosed, in accordance with certain aspects. In the embodiment depicted in FIG. 10, cloud infrastructure system 1002 may provide one or more cloud services that may be requested by users using one or more client computing devices 1004, 1006, and 1008. Cloud infrastructure system 1002 may comprise one or more computers and/or servers that may include those described above for server 914. The computers in cloud infrastructure system 1002 may be organized as general purpose computers, specialized server computers, server farms, server clusters, or any other appropriate arrangement and/or combination.

Network(s) 1010 may facilitate communication and exchange of data between clients 1004, 1006, and 1008 and cloud infrastructure system 1002. Network(s) 1010 may include one or more networks. The networks may be of the same or different types. Network(s) 1010 may support one or more communication protocols, including wired and/or wireless protocols, for facilitating the communications.

The embodiment depicted in FIG. 10 is only one example of a cloud infrastructure system and is not intended to be limiting. It should be appreciated that, in some other aspects, cloud infrastructure system 1002 may have more or fewer components than those depicted in FIG. 10, may combine two or more components, or may have a different configuration or arrangement of components. For example, although FIG. 10 depicts three client computing devices, any number of client computing devices may be supported in alternative aspects.

The term cloud service is generally used to refer to a service that is made available to users on demand and via a communication network such as the Internet by systems (e.g., cloud infrastructure system 1002) of a service provider. Typically, in a public cloud environment, servers and systems that make up the cloud service provider's system are different from the cloud customer’s (“tenant’s”) own on-premise servers and systems. The cloud service provider’s systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1010 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1002 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1002 may include a suite of databases, middleware, applications, and/or other resources that enable provision of the various cloud services.

A SaaS model enables an application or software to be delivered to a tenant’s client device over a communication network like the Internet, as a service, without the tenant having to buy the hardware or software for the underlying application. For example, a SaaS model may be used to provide tenants access to on-demand applications that are hosted by cloud infrastructure system 1002. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription service order, may order one or more services provided by cloud infrastructure system 1002. Cloud infrastructure system 1002 then performs processing to provide the services requested in the tenant's subscription service order. Cloud infrastructure system 1002 may be configured to provide one or even multiple cloud services.

Cloud infrastructure system 1002 may provide the cloud services via different deployment models. In a public cloud model, cloud infrastructure system 1002 may be owned by a third party cloud services provider and the cloud services are offered to any general public tenant, where the tenant can be an individual or an enterprise. In certain other aspects, under a private cloud model, cloud infrastructure system 1002 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1002 and the services provided may be shared by several organizations in a related community. Various other models such as hybrids of the above mentioned models may also be used.

Client computing devices 1004, 1006, and 1008 may be of different types (such as devices 902, 904, 906, and 908 depicted in FIG. 9) and may be capable of operating one or more client applications. A user may use a client device to interact with cloud infrastructure system 1002, such as to request a service provided by cloud infrastructure system 1002.

In some aspects, the processing performed by cloud infrastructure system 1002 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1002 for determining the intent of an utterance. The data used for this analysis may include structured data (e.g., data stored in a database or structured according to a structured model) and/or unstructured data (e.g., data blobs (binary large objects)).

As depicted in the embodiment in FIG. 10, cloud infrastructure system 1002 may include infrastructure resources bthat are utilized for facilitating the provision of various cloud services offered by cloud infrastructure system 1002. Infrastructure resources 1030 may include, for example, processing resources, storage or memory resources, networking resources, and the like.

In certain aspects, to facilitate efficient provisioning of these resources for supporting the various cloud services provided by cloud infrastructure system 1002 for different tenants, the resources may be bundled into sets of resources or resource modules (also referred to as "pods"). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1002 may itself internally use services 1032 that are shared by different components of cloud infrastructure system 1002 and which facilitate the provisioning of services by cloud infrastructure system 1002. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1002 may comprise multiple subsystems. These subsystems may be implemented in software, or hardware, or combinations thereof. As depicted in FIG. 10, the subsystems may include a user interface subsystem 1012 that enables users of cloud infrastructure system 1002 to interact with cloud infrastructure system 1002. User interface subsystem 1012 may include various different interfaces such as a web interface 1014, an online store interface 1016 where cloud services provided by cloud infrastructure system 1002 are advertised and are purchasable by a consumer, and other interfaces 1018. For example, a tenant may, using a client device, request (service request 1034) one or more services provided by cloud infrastructure system 1002 using one or more of interfaces 1014, 1016, and 1018. For example, a tenant may access the online store, browse cloud services offered by cloud infrastructure system 1002, and place a subscription service order for one or more services offered by cloud infrastructure system 1002 that the tenant wishes to subscribe to. The service request may include information identifying the tenant and one or more services that the tenant desires to subscribe to. For example, a tenant may place a subscription service order for a chatbot related service offered by cloud infrastructure system 1002. As part of the service order, the client may provide information identifying the input (e.g. utterances).

In certain aspects, such as the embodiment depicted in FIG. 10, cloud infrastructure system 1002 may comprise service management subsystem 1020 that is configured to process the new service order for a service offered by the cloud environment. As part of this processing, the service management subsystem 1020 may be configured to: create an account for the tenant, if not done already; receive billing and/or accounting information from the tenant that is to be used for billing the tenant for providing the requested service to the tenant; verify the tenant information; upon verification, book the service order for the service for the tenant; and orchestrate various workflows to prepare the service order for provisioning.

Once properly validated, the service management subsystem 1020 may then invoke a service provisioning subsystem 1024 that is configured to provision resources for the service order including processing, memory, and networking resources. The provisioning may include allocating resources for the service order for the service and configuring the resources to facilitate the service requested by the tenant service order. The manner in which resources are provisioned for an order and the type of the provisioned resources may depend upon the type of cloud service that has been ordered by the tenant. For example, according to one workflow, the service provisioning subsystem 1024 may be configured to determine the particular cloud service being requested and identify a number of pods that may have been pre-configured for that particular cloud service. The number of pods that are allocated for a service order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1002 may send a response or notification 1044 to the requesting tenant to indicate when the requested service is now ready for use. In some instances, information (e.g., a link) may be sent to the tenant that enables the tenant to start using and availing the benefits of the requested services.

Cloud infrastructure system 1002 may provide services to multiple tenants. For each tenant, cloud infrastructure system 1002 is responsible for managing information related to one or more subscription service orders received from the tenant, maintaining tenant data related to the service orders, and providing the requested services to the tenant or clients of the tenant. Cloud infrastructure system 1002 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1002 may provide services to multiple tenants in parallel. Cloud infrastructure system 1002 may store information for these tenants, including possibly proprietary information. In certain aspects, cloud infrastructure system 1002 comprises an identity management subsystem (IMS) 1028 that is configured to manage tenant’s information and provide the separation of the managed information such that information related to one tenant is not accessible by another tenant. IMS 1028 may be configured to provide various security-related services such as identity services, such as information access management, authentication and authorization services, services for managing tenant identities and roles and related capabilities, and the like.

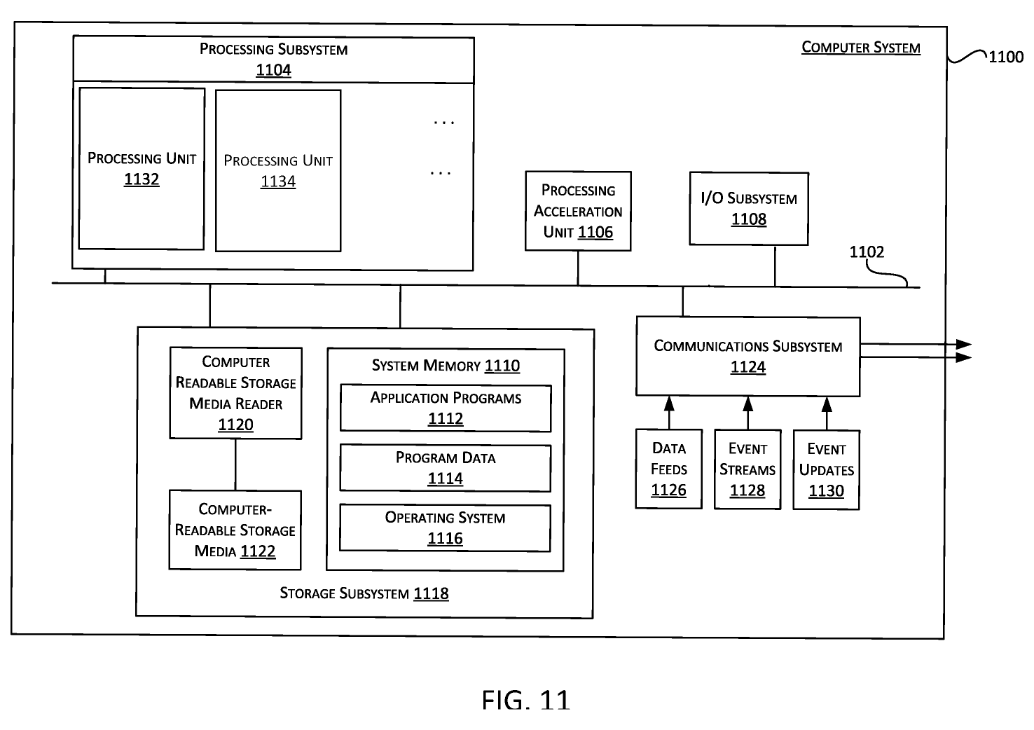

FIG. 11 illustrates an exemplary computer system 1100 that may be used to implement certain aspects. As shown in FIG. 11, computer system 1100 includes various subsystems including a processing subsystem 1104 that communicates with a number of other subsystems via a bus subsystem 1102. These other subsystems may include a processing acceleration unit 1106, an I/O subsystem 1108, a storage subsystem 1118, and a communications subsystem 1124. Storage subsystem 1118 may include non-transitory computer-readable storage media including storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative aspects of the bus subsystem may utilize multiple buses. Bus subsystem 1102 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1104 controls the operation of computer system 1100 and may comprise one or more processors, application specific integrated circuits (ASICs), or field programmable gate arrays (FPGAs). The processors may be single core or multicore processors. The processing resources of computer system 1100 can be organized into one or more processing units 1132, 1134, etc. A processing unit may include one or more processors, one or more cores from the same or different processors, a combination of cores and processors, or other combinations of cores and processors. In some aspects, processing subsystem 1104 can include one or more special purpose co-processors such as graphics processors, digital signal processors (DSPs), or the like. In some aspects, some or all of the processing units of processing subsystem 1104 can be implemented using customized circuits, such as application specific integrated circuits (ASICs), or field programmable gate arrays (FPGAs).

In some aspects, the processing units in processing subsystem 1104 can execute instructions stored in system memory 1110 or on computer readable storage media 1122. In various aspects, the processing units can execute a variety of programs or code instructions and can maintain multiple concurrently executing programs or processes. At any given time, some or all of the program code to be executed can be resident in system memory 1110 and/or on computer-readable storage media 1122 including potentially on one or more storage devices. Through suitable programming, processing subsystem 1104 can provide various functionalities described above. In instances where computer system 1100 is executing one or more virtual machines, one or more processing units may be allocated to each virtual machine.

In certain aspects, a processing acceleration unit 1106 may optionally be provided for performing customized processing or for off-loading some of the processing performed by processing subsystem 1104 so as to accelerate the overall processing performed by computer system 1100.

I/O subsystem 1108 may include devices and mechanisms for inputting information to computer system 1100 and/or for outputting information from or via computer system 1100. In general, use of the term input device is intended to include all possible types of devices and mechanisms for inputting information to computer system 1100. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., "blinking" while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1100 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1118 provides a repository or data store for storing information and data that is used by computer system 1100. Storage subsystem 1118 provides a tangible non-transitory computer-readable storage medium for storing the basic programming and data constructs that provide the functionality of some aspects. Storage subsystem 1118 may store software (e.g., programs, code modules, instructions) that when executed by processing subsystem 1104 provides the functionality described above. The software may be executed by one or more processing units of processing subsystem 1104. Storage subsystem 1118 may also provide a repository for storing data used in accordance with the teachings of this disclosure.

Storage subsystem 1118 may include one or more non-transitory memory devices, including volatile and non-volatile memory devices. As shown in FIG. 11, storage subsystem 1118 includes a system memory 1110 and a computer-readable storage media 1122. System memory 1110 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1100, such as during start-up, may typically be stored in the ROM. The RAM typically contains data and/or program modules that are presently being operated and executed by processing subsystem 1104. In some implementations, system memory 1110 may include multiple different types of memory, such as static random access memory (SRAM), dynamic random access memory (DRAM), and the like.

By way of example, and not limitation, as depicted in FIG. 11, system memory 1110 may load application programs 1112 that are being executed, which may include various applications such as Web browsers, mid-tier applications, relational database management systems (RDBMS), etc., program data 1114, and an operating system 1116. By way of example, operating system 1116 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1122 may store programming and data constructs that provide the functionality of some aspects. Computer-readable media 1122 may provide storage of computer-readable instructions, data structures, program modules, and other data for computer system 1100. Software (programs, code modules, instructions) that, when executed by processing subsystem 1104 provides the functionality described above, may be stored in storage subsystem 1118. By way of example, computer-readable storage media 1122 may include non-volatile memory such as a hard disk drive, a magnetic disk drive, an optical disk drive such as a CD ROM, digital video disc (DVD), a Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1118 may also include a computer-readable storage media reader 1120 that can further be connected to computer-readable storage media 1122. Reader 1120 may receive and be configured to read data from a memory device such as a disk, a flash drive, etc.

In certain aspects, computer system 1100 may support virtualization technologies, including but not limited to virtualization of processing and memory resources. For example, computer system 1100 may provide support for executing one or more virtual machines. In certain aspects, computer system 1100 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1100. Accordingly, multiple operating systems may potentially be run concurrently by computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to establish a communication channel to one or more client devices via the Internet for receiving and sending information from and to the client devices. For example, the communications subsystem may be used to transmit a response to a user regarding the inquiry for a chatbot.

Communications subsystem 1124 may support both wired and/or wireless communication protocols. For example, in certain aspects, communications subsystem 1124 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1124 can provide wired network connectivity (e.g., Ethernet) in addition to or instead of a wireless interface.

Communications subsystem 1124 can receive and transmit data in various forms. For example, in some aspects, in addition to other forms, communications subsystem 1124 may receive input communications in the form of structured and/or unstructured data feeds 1126, event streams 1128, event updates 1130, and the like. For example, communications subsystem 1124 may be configured to receive (or send) data feeds 1126 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1124 may be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to communicate data from computer system 1100 to other computer systems or networks. The data may be communicated in various different forms such as structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1100 depicted in FIG. 11 is intended only as a specific example. Many other configurations having more or fewer components than the system depicted in FIG. 11 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A non-transitory computer-readable medium including instructions that when executed by one or more processors, cause the one or more processors to perform operations including:
establishing a customer section within a cloud environment, the customer section comprising a plurality of customer cloud resources configured to execute customer workload;
establishing a plurality of control layers, each control layer corresponding to a respective cloud restriction type, wherein the cloud restriction types comprise at least two of:
a first cloud restriction type associated with prohibiting gateways that are attached to the customer section and not a restricting section;
a second cloud restriction type associated with prohibiting transmission of traffic based on caller credentials;
a third cloud restriction type associated with prohibiting transmission of traffic based on at least one API request type or API request parameters;
a fourth cloud restriction type associated with routing traffic to and/or from the customer section through the restricting section, wherein the restricting section comprises a plurality of monitoring cloud resources;
a fifth cloud restriction type associated with a security zone that encompasses at least a portion of the customer section;
a sixth cloud restriction type associated with engaging locks on one or more of the plurality of customer cloud resources within the customer section, wherein any user and/or administrator of the customer section cannot control engaging and/or disengaging the locks;
a seventh cloud restriction type associated with setting an upper limit for a type of operation to be performed by the customer section, or an upper limit for a type of resource to be accessed by the customer section, such that a number of times the type of operation can be performed or a number of times the type of resource can be accessed by the customer section is limited by the upper limit; and
an eighth cloud restriction type associated with monitoring and recoding a secure shell (SSH) session or a zero trust bastion (ZTB) session in which the customer section participates;
restricting the traffic to and/or from the customer section at least by applying the plurality of control layers to the traffic to and/or from the customer section.

2. The non-transitory computer-readable medium of claim 1, wherein the operations include:
storing one or more keys within a tenancy of the cloud environment, the tenancy different from the customer section, wherein a key of the one or more keys is usable to unlock at least one cloud restriction type, such that the at least one cloud restriction type can be modified, deleted, and/or bypassed while being unlocked by the key of the one or more keys.

3. The non-transitory computer-readable medium of claim 2, wherein the one or more keys comprise at least one of (i) an encryption key usable to unlock the at least one cloud restriction type, (ii) a session token usable to unlock the at least one cloud restriction type, and (iii) a user principal usable to unlock the at least one cloud restriction type, wherein the keys are non-accessible to any user or any administrator of the customer section.

4. The non-transitory computer-readable medium of claim 1, wherein the operations include:
causing to store one or more restriction policies within the customer section, wherein at least one cloud restriction types operate in accordance with the one or more restriction policies.

5. The non-transitory computer-readable medium of claim 1, wherein the operations include:
causing to store one or more security zone policies, wherein the one or more security zone policies are associated with the security zone within the customer section, such that any ingress application programming interface (API) request inbound to any cloud resource within the security zone is allowed or denied passage to its destination in accordance with the one or more security zone policies.

6. The non-transitory computer-readable medium of claim 5, wherein the operations include:
causing to store one or more security zone unlocking policies within the customer section, wherein the one or more security zone unlocking policies are associated with restriction actions undertaken while at least one of the one or more security zone policies is at an unlocked state.

7. The non-transitory computer-readable medium of claim 1, wherein routing traffic to and/or from the customer section through the restricting section comprises:
routing all traffic to and from the customer section through one or more gateways of the restricting section of the cloud environment.

8. The non-transitory computer-readable medium of claim 1, wherein the operations further include:
analyzing, using one or more of the plurality of monitoring cloud resources, at least some of the traffic routed through the restricting section, aiming detect anomalous issues within a plurality of payloads within the at least some of the traffic; and
selectively allowing or denying passage of each payload to its corresponding destination, based at least in part on whether any anomalous issue was detected for the payload.

9. The non-transitory computer-readable medium of claim 1, wherein the first cloud restriction type associated with prohibiting gateways allows gateways within the restricting section, such that external access to the customer section is through the restricting section of the cloud environment.

10. The non-transitory computer-readable medium of claim 1, wherein the seventh cloud restriction type associated with setting the upper limit comprises setting an upper limit on a number public endpoints that the restricted customer section has access to.

11. The non-transitory computer-readable medium of claim 1, wherein the cloud restriction types comprise each of the first cloud restriction type, the second cloud restriction type, the third cloud restriction type, the fourth cloud restriction, the fifth cloud restriction type, the sixth cloud restriction type, the seventh cloud restriction type, and the eighth cloud restriction type.

12. The non-transitory computer-readable medium of claim 1, wherein the customer section is a customer tenancy rented to a cloud customer, or a compartment within the customer tenancy rented to the cloud customer.

13. The non-transitory computer-readable medium of claim 1, wherein the restricting section comprises a gateway tenancy operated by an assurance administrator.

14. The non-transitory computer-readable medium of claim 1, wherein any user and administrator of the customer section does not have administrative privileges to alter or configure any of the restriction types.

15. A method comprising:
establishing a customer section within a cloud environment, the customer section comprising a plurality of customer cloud resources configured to execute customer workload;
establishing a plurality of control layers, each control layer corresponding to a respective cloud restriction type, wherein the cloud restriction types comprise at least two of:
a first cloud restriction type associated with prohibiting gateways that are attached to the customer section and not a restricting section;
a second cloud restriction type associated with prohibiting transmission of traffic based on caller credentials;
a third cloud restriction type associated with prohibiting transmission of traffic based on at least one API request type or API request parameters;
a fourth cloud restriction type associated with routing traffic to and/or from the customer section through the restricting section, wherein the restricting section comprises a plurality of monitoring cloud resources;
a fifth cloud restriction type associated with a security zone that encompasses at least a portion of the customer section;
a sixth cloud restriction type associated with engaging locks on one or more of the plurality of customer cloud resources within the customer section, wherein any user and/or administrator of the customer section cannot control engaging and/or disengaging the locks;
a seventh cloud restriction type associated with setting an upper limit for a type of operation to be performed by the customer section, or an upper limit for a type of resource to be accessed by the customer section, such that a number of times the type of operation can be performed or a number of times the type of resource can be accessed by the customer section is limited by the upper limit; and
an eighth cloud restriction type associated with monitoring and recoding a secure shell (SSH) session or a zero trust bastion (ZTB) session in which the customer section participates;
restricting the traffic to and/or from the customer section at least by applying the plurality of control layers to the traffic to and/or from the customer section.

16. The method of claim 15, wherein any user and administrator of the customer section does not have administrative privileges to alter or configure any of the restriction types.

17. The method of claim 15, wherein the customer section is a customer tenancy rented to a cloud customer, or a compartment within the customer tenancy rented to the cloud customer, and wherein the restricting section comprises a gateway tenancy operated by an assurance administrator.

18. The method of claim 15, wherein the operations further include:
analyzing, using one or more of the plurality of monitoring cloud resources, at least some of the traffic routed through the restricting section, aiming detect anomalous issues within a plurality of payloads within the at least some of the traffic; and
selectively allowing or denying passage of each payload to its corresponding destination, based at least in part on whether any anomalous issue was detected for the payload.

19. A system comprising:
one or more processors; and
one or more non-transitory computer-readable media storing instructions, which, when executed by the system, cause the system to perform a set of actions including:
establishing a customer section within a cloud environment, the customer section comprising a plurality of customer cloud resources configured to execute customer workload;
establishing a plurality of control layers, each control layer corresponding to a respective cloud restriction type, wherein the cloud restriction types comprise at least two of:
a first cloud restriction type associated with prohibiting gateways that are attached to the customer section and not a restricting section;
a second cloud restriction type associated with prohibiting transmission of traffic based on caller credentials;
a third cloud restriction type associated with prohibiting transmission of traffic based on at least one API request type or API request parameters;
a fourth cloud restriction type associated with routing traffic to and/or from the customer section through the restricting section, wherein the restricting section comprises a plurality of monitoring cloud resources;
a fifth cloud restriction type associated with a security zone that encompasses at least a portion of the customer section;
a sixth cloud restriction type associated with engaging locks on one or more of the plurality of customer cloud resources within the customer section, wherein any user and/or administrator of the customer section cannot control engaging and/or disengaging the locks;
a seventh cloud restriction type associated with setting an upper limit for a type of operation to be performed by the customer section, or an upper limit for a type of resource to be accessed by the customer section, such that a number of times the type of operation can be performed or a number of times the type of resource can be accessed by the customer section is limited by the upper limit; and
an eighth cloud restriction type associated with monitoring and recoding a secure shell (SSH) session or a zero trust bastion (ZTB) session in which the customer section participates;
restricting the traffic to and/or from the customer section at least by applying the plurality of control layers to the traffic to and/or from the customer section.

20. The system of claim 19, wherein any user and administrator of the customer section does not have administrative privileges to alter or configure any of the restriction types.
